(19) United States
(12) Patent Application Publication
(10) Pub. No.: US 2026/0184876 A1
(43) Pub. Date: Jul. 2, 2026

(54) COLORANT REMOVAL FROM POLYESTER MATERIALS FOR RECYCLING

(71) Applicant: International Business Machines Corporation, Armonk, NY (US)

(72) Inventors: Gregory Breyta, San Jose, CA (US); Ting-Han Lee, San Jose, CA (US)

(21) Appl. No.: 19/424,436

(22) Filed: Dec. 18, 2025

Related U.S. Application Data
(60) Provisional application No. 63/740,393, filed on Dec. 31, 2024.

(51) Int. Cl. C08J 11/02; D06P 5/13

(52) U.S. Cl. CPC C08J 11/02; D06P 5/13; C08J 2367/03; D10B 2331/04

(57) ABSTRACT

Chemical processing techniques for removing colorant from polyester materials for recycling are described. According to an embodiment, a method for producing a purified polyester material, can comprise contacting a heated solution comprising a solvent to a polyester material as positioned within a vessel, wherein the polyester material comprises one or more additive components, and removing at least some of the one or more additive components from the polyester material as a result of the contacting, resulting in a transformation of the polyester material into the purified polyester material. In an example, the solvent comprises a ketone, an ether, an ester, an alcohol and/or a carbonate. The one or more additive components can include a colorant and/or other contaminates.

### TECHNICAL FIELD

The subject disclosure relates generally to chemical processing techniques for removing colorants and other components from polyester materials for recycling.

### BACKGROUND

Polyester is amongst the most commonly used global fiber market, ubiquitous in the fashion industry. The global fiber production reached 116 million tons in 2022, with synthetic fibers accounting for 65% of this total. Polyester fiber production alone reached 63.3 million tons, representing 54% of global fiber production. With continued population growth, global fiber production is expected to keep increasing at an annual growth rate of 1.2%. However, this significant production volume also leads to the generation of a large amount of textile waste. Less than 1% of textile waste is recycled fiber-to-fiber, with approximately 73% landfilled or incinerated, 14% lost during production and collection, and 12% downcycled into lower-value applications.

Highly colored polyester feedstocks are difficult to recycle using current technology and thus are often disposed of in a landfill or by incineration. Although methods exist for the removal of colorants from polyester material prior to recycling, these methods use toxic chemicals and have other substantial drawbacks. Thus, the vast majority of polyesters, being colored, are them unsuitable for use in many downstream recycled products. Current methods of colorant removal from polyester materials for the purposes of recycling include pre-processing decolorization and post-processing decolorization.

With pre-processing decolorization, the colored material is soaked in an aqueous or organic solvent that extracts the dye or alternatively, the colored material is subjected to high-shear mixing. With the solvent soaking method, the solubility limits of the colorant material in the solvent and/or the relative partitioning of the colorant in the solvent versus the polymer limit the efficiency of the colorant extraction. Because of these limits, there is always a substantial amount of colorant remaining in the polyester. To partially circumvent this problem, large amounts of solvent are required, which render the process economically or environmentally unsuitable for commercial use. With the high-shear mixing, specific equipment and solvents are required that complicate the colorant extraction. For example, the solvent used in high-shear mixing decolorization is an ionic liquid, which requires mixing with water to remove the dye, and the water must be evaporated from the solution in order to reuse the solvent. Water requires a large quantity of energy to evaporate, a step that limits the economic viability of the process.

With post-processing decolorization of recycled polyester material, the polymer is depolymerized to oligomeric or monomeric materials, then the color is removed from a solution of the depolymerized material in a solvent, often with activated carbon or other adsorption materials for a colorant extraction process. With solution color removal, the oligomer/monomer solution is exposed to an adsorbent, such as activated carbon, to remove the dissolved colorants. While solvent color removal is capable of removing limited amounts of colorants, the process is overwhelmed by the large quantities of colorants found in dark-colored fabrics resulting in a technical and economic hurdle. To partially circumvent this problem, large amounts of adsorbent can be used, but this renders the process economically unsuitable for commercial use.

In view of the foregoing, there remains a need in the art for a more efficient method of colorant removal from polyester materials in association with usage of the decolorized polyester materials for generating recycled products.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later.

According to an embodiment, a method for producing a purified polyester material is provided. The method comprises contacting a heated solution comprising a solvent to a polyester material as positioned within a vessel, wherein the polyester material comprises one or more additive components, and wherein the solvent is selected from the group consisting of: a ketone, an ether, an ester, an alcohol and a carbonate. The method further comprises removing at least some of the one or more additive components from the polyester material as a result of the contacting, resulting in a transformation of the polyester material into the purified polyester material.

In an aspect, the at least some of the one or more additive components comprise a colorant. Additionally, or alternatively, the at least some of the one or more additive components are selected from the group consisting of: a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime. In an aspect, the solvent is selected from the group consisting of: cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate.

According to another embodiment, another method for producing a purified polyester material can comprise placing a polyester material in a chamber of a continuous flow reaction system for a duration of time, wherein the polyester material comprises one or more additive components, and performing an extraction process over the duration of time using the continuous flow reaction system, wherein the reaction process comprises contacting a condensed solvent solution comprising a solvent to the polyester material as positioned within the chamber, wherein the solvent is selected from the group consisting of: a ketone, an ether, an ester, an alcohol and a carbonate. The method further comprises removing at least some of the one or more additive components from the polyester material as a result of the performing, resulting in a transformation of the polyester material into the purified polyester material, and removing the purified polyester material from the chamber.

In an aspect, the continuous flow reaction system comprises a condenser and a boiling vessel respectively coupled to the chamber, and wherein the reaction process comprises repeatedly or continuously: forming a mixture comprising the condensed solvent solution and an extracted amount of the colorant within the chamber as a result of the contacting; collecting the mixture within the boiling vessel; heating the boiling vessel to transform the solvent within the mixture into a vaporized solvent, wherein the vaporized solvent travels into the condenser and forms the condensed solvent solution; and directing the condensed solvent solution into the chamber.

In an aspect, the at least some of the one or more additive components comprise a colorant. Additionally, or alternatively, the at least some of the one or more additive components are selected from the group consisting of: a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime. In an aspect, the solvent is selected from the group consisting of: cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate.

In various embodiments, the solvent used to extract additive components from polyester material using the methods described herein can be recovered and reused.

In various embodiments, the purified polyester material obtained via the methods described herein can further be transformed into a recycled polyester material via a chemical and/or mechanical recycling process.

In some embodiments, colorant removed from polyester material using the methods described herein can be recovered and used to dye another material.

### BRIEF DESCRIPTION OF THE DRAWINGS

The Applicant hereby petitions the Director to accept color drawings and [or photographs in this application. The color drawings and photographs are necessary as the subject matter cannot be adequately understood in black and white.

One or more embodiments are described below in the Detailed Description section with reference to the following drawings:

FIG. 1 illustrates a flow diagram of an example, non-limiting method for removing one or more additive components from a polyester material in accordance with one or more embodiments described herein;

FIG. 2 illustrates a flow diagram of an example, non-limiting method for recycling a polyester material in accordance with one or more embodiments described herein;

FIG. 3 presents chemical structures of several example colorants capable of being removed from polyester material, in accordance with one or more embodiments described herein.

FIG. 4 presents an example, non-limiting extraction system for removing one or more additive components from a polyester material in accordance with one or more embodiments described herein;

FIG. 5 presents polyester fabric samples before and after colorant removal in accordance with one or more embodiments described herein;

FIG. 6 illustrates a flow diagram of another example, non-limiting method for removing one or more additive components from a polyester material in accordance with one or more embodiments described herein;

FIG. 7 illustrates an example continuous flow reaction system in accordance with one or more embodiments described herein;

FIG. 8 illustrates a flow diagram of an example continuous flow reaction process using the continuous flow reaction system presented in FIG. 7;

FIG. 9 illustrates another example continuous flow reaction system in accordance with one or more embodiments described herein;

FIG. 10 illustrates another example continuous flow reaction system in accordance with one or more embodiments described herein;

FIG. 11 illustrates another example continuous flow reaction system in accordance with one or more embodiments described herein;

FIG. 12 illustrates an example implementation of a chemical recycling process for transforming a purified polyester material into a recycled polyester material, in accordance with one or more embodiments described herein.

FIG. 13 presents example polyester fabric samples following colorant removal using different solvents in accordance with Experiment 3;

FIG. 14 presents a table illustrating results of Experiment 4;

FIG. 15 presents different fabric samples before and after colorant removal in accordance with Experiment 4;

FIG. 16 presents the nuclear magnetic resonance (NMR) analysis of the material extracted from Sample 1 in accordance with Experiment 4;

FIG. 17 presents the fluorine NMR (F-NMR) analysis of extracted PFAS material from Sample 13 in accordance with Experiment 5;

FIG. 18 presents the F-NMR analysis of extracted PFAS material from Sample 14 in accordance with Experiment 5;

FIG. 19 presents an image demonstrating optical brightener removal in accordance with Experiment 5;

FIG. 20 demonstrates the efficacy of dying white PET fabric with disperse dye extracted in accordance with Experiment 3.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The present innovation overcomes the need in the art with an efficient extraction

process that removes colorant from polyester materials with one or more organic, non-toxic solvents at elevated temperatures. In various embodiments, the organic solvent includes a ketone, an ether, an ester, a carbonate or combinations thereof. For example, the organic solvent can include, but is not limited to: cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate. Upon completion of the extraction process, the decolored polyester material may be transformed into a recycled polyester material via a chemical and/or mechanical recycling process. The disclosed extraction process also removes other additives from polyester feedstock that may contaminate the recycled polyester material, such as but not limited to: lubricants, brighteners, perfluoroalkyl substances, polyfluoroalkyl substances, scouring agents, anti-foam agents, leveling agents, and wicking agents, antistatic compounds, water repellents, emulsifiers, surfactants, flame retardants, other washing and dye bath additives, as well as contaminants such as dirt and grime. In addition, in some embodiments, the extraction processes efficiently recover and reuse the purified organic solvent for additional extractions, such as in a continuous flow loop. Further, the extraction processes can collect the removed colorant which may be reused to dye other materials.

The disclosed extraction processes leverage the mechanism of polyester fabric dying process at certain temperature (110-130° C.), which is usually higher than the glass transition temperature (Tg) of polyester. Under this condition, the amorphous region of the polyester fiber becomes partially molecularly mobile and swellable, allowing dye molecules to disperse within the amorphous regions of the fibers. Therefore, instead of presenting how to embed additives into uncolored polyester fabric, this application demonstrates the effectiveness to extract additives from colored polyester fabric after dying processing based on an inverse mechanism.

Various methods are provided to remove colorant and other contaminants from polyester materials prior to introduction of the polyester materials into a chemical recycling process. In some embodiments, colorant and other additives are removed from polyester material by contacting a heating solution comprising a solvent to the polyester material as positioned within a vessel. In other embodiments, colorant and other additives are removed from the polyester material by exposing the material to a continuously condensed hot solvent that passes through the material and extracts colorant compounds that are incorporated into the fibers of the polyester material. The solvent that has passed through the material may be subsequently recollected, reevaporated, recondensed, and passed back through the material to extract additional color. The evaporation-condensation-extraction loop results in a polyester material that is decolored and a colored solvent with a high concentration of colorant.

In all embodiments, the solvent comprises a non-toxic solvent, such as but not limited to: a ketone, an ether, an ester, and/or a carbonate. For example, the solvent may include but is not limited to, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate, ethyl acetate and/or combinations thereof.

When the extraction process is complete, the decolored polyester material may be recovered and recycled in a chemical recycling process or a mechanical recycling process. The colored solvent obtained at the completion of the color extraction may be separated from the colorant by evaporation, distillation and/or filtration. Upon separation, the solvent may be reused for additional color extractions and the colorant may be reused for the dying of new materials. In addition, the colorant extracted can be recovered and used to dye other materials.

The methods may be used with any fabric feedstock containing polyester that has been colored with any type of pigment, dye, optical brightener, and/or ink. The methods may also be used with white (not dyed) or lightly colored fabric to remove other impurities included in the fabric (e.g., brighteners, lubricants, perfluoroalkyl substances, polyfluoroalkyl substances, scouring agents, anti-foam agents, leveling agents, wicking agents, antistatic compounds, water repellents, emulsifiers, surfactants, flame retardants, other washing and dye bath additives, as well as contaminants such as dirt and grime.). The methods may also be used with mixed fabric feedstocks containing colored polyester and/or other materials (e.g., cellulose materials, cotton, nylons, polyurethanes, acrylics, silk, wool, polyether materials, elastane materials and other elastomers). The methods can also be applied to extract colorant and other contaminates from polyester material formed as granulates, pellets or bottle flake.

One non-limiting example of a chemical recycling process that may use the purified textile products of the disclosed methods in implementation in which they include polyester is the glycolysis-based process (also referred to as the volatile catalyst (VolCat) method) described in U.S. Pat. No. 9,255,194 B2 to Allen et al. and U.S. Pat. No. 9,914,816 B2 to Allen et al. This glycolysis-based process depolymerizes polyester with an alcohol solvent and an amine organocatalyst and/or carboxylic acid salt of the same in a reactor at a temperature at or higher than the boiling point of the alcohol solvent. Reaction products from glycolysis-based depolymerization are monomeric and/or oligomeric diesters from the polyester as well as recovered organocatalyst and excess alcohol solvent, the former of which is intended for reuse into recycled polyester products and the latter of which may also be reused in subsequent depolymerization reactions.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

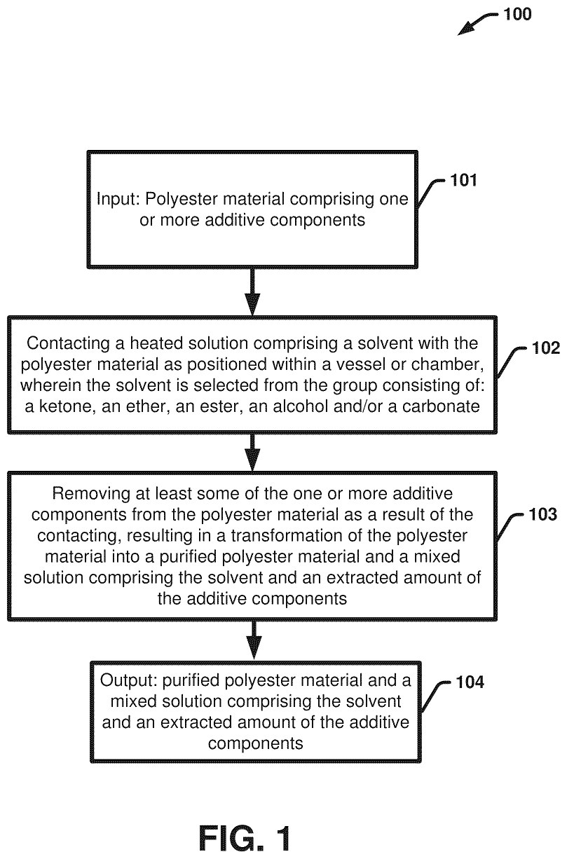

FIG. 1 illustrates a flow diagram of an example, non-limiting method 100 for removing one or more additive components from a polyester material in accordance with one or more embodiments described herein. The input to method 100 comprises a polyester material 101 comprising one or more additive components. The output 104 of method 100 comprises a purified polyester material that excludes at least some of the one or more additive components, and a mixed solution comprising the solvent and an extracted amount of the additive components.

At 102, method 100 comprises contacting a heated solution comprising a solvent with the polyester material as positioned within a vessel or chamber, wherein the solvent is selected from the group consisting of: a ketone, an ether, an ester, an alcohol and/or a carbonate. In various embodiments, the solvent can include, but is not limited to, cyclopentanone (CPO), cyclohexanone, 1,4-dioxane, 1,3-dioxolane, tetrahydrofuran, 2-methyl tetrahydrofuran, dimethyl carbonate, diethyl carbonate, ethyl lactate, ethyl acetate and/or combinations thereof. Hereinafter, reference to a solvent solution assumes the solvent solution comprises at least one of the aforementioned solvents, unless otherwise noted. At 103, method 100 comprises removing at least some of the one or more additive components from the polyester material as a result of the contacting, resulting in a transformation of the polyester material 101 into a purified polyester material and a mixed solution comprising the solvent and an extracted amount of the additive components (e.g., output 104).

In this regard, the purified polyester material excludes at least some of the one or more additive components relative to the polyester material 101. As described in greater detail throughout, the amount of additive components removed from the polyester material 101 via method 100 and other methods described herein can vary depending on the solvent used from amongst the disclosed solvents, the duration of contacting, the type of additive components to be removed, the solubility of the additive components, the amount of additive components included in the polyester material 101, the temperature of the heated solvent, and other factors. With the embodiments described herein, these factors can be tailored to obtain a purified polyester material that has less than 2.0 percent by weight of the one or more additive components and/or less than 1.0 percent by weight of the one or more additive components.

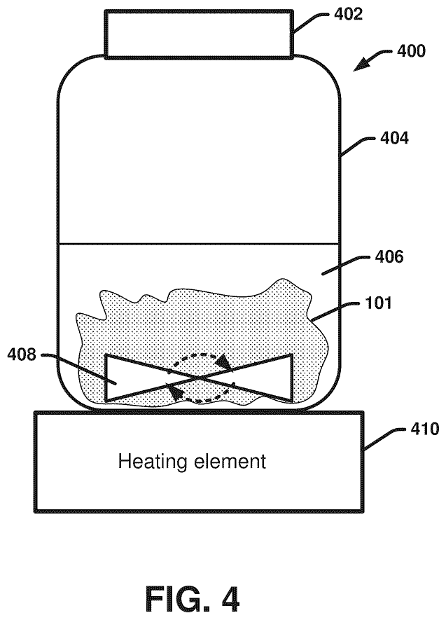

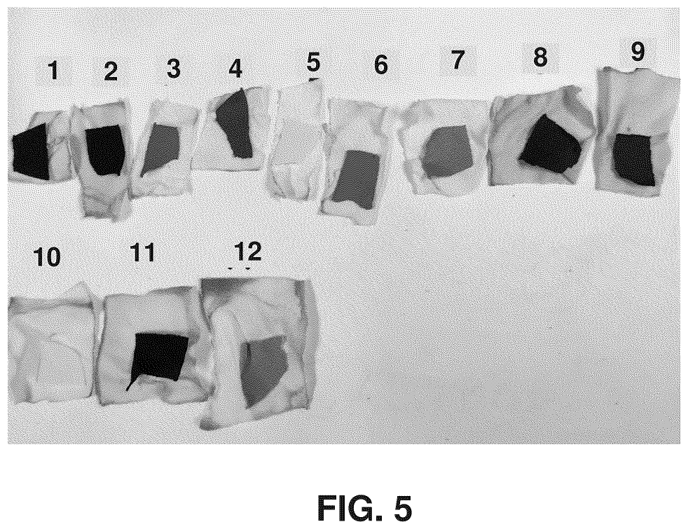

In various embodiments, the contacting of method 100 can be performed using extraction system 400 (or a similar extraction system) as described with reference to FIG. 4. With these embodiments, the polyester material 101 and the solvent solution are placed within a vessel which is heated to raise the temperature of the solvent solution to a target temperature for a duration of time. In some implementations of these embodiments, the target temperature is between about 50° C. to about 130° C. and the duration of time is between about 1 minute and about 15 minutes. In other implementations of these embodiments, the target temperature is between about 70° C. to about 130° C. and the duration of time is between about 2 minutes and about 10 minutes. Additional details regarding the execution of method 100 using extraction system 400 (or a similar extraction system) are described with reference to FIGS. 4 and 5.

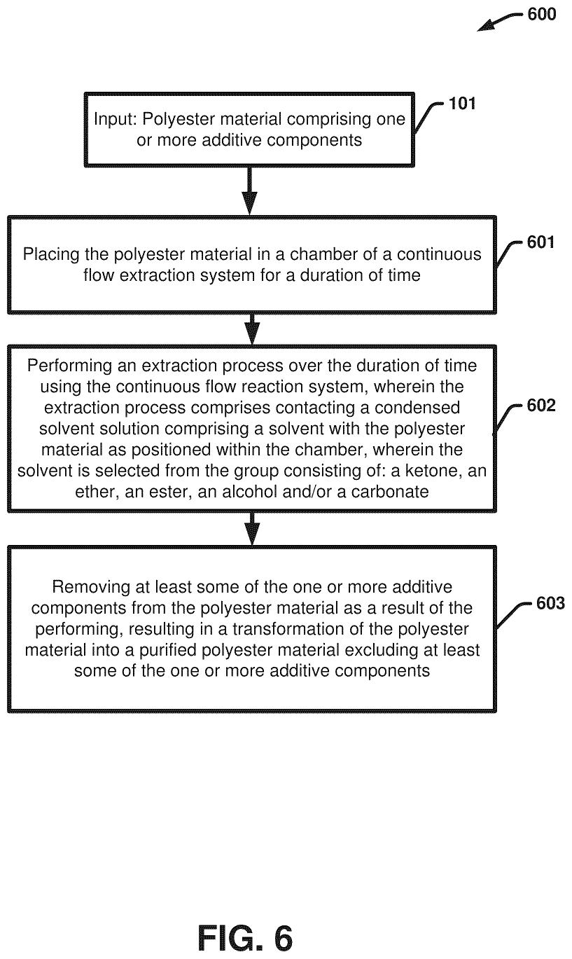

In other embodiments, the contacting of method 100 can be performed using a continuous flow reaction system, as described with reference to FIGS. 6-11. With these embodiments, the polyester material is placed withing a chamber for a duration of time and contacted with the heated solvent solution over the duration of time in a continuous or cyclical manner. With these embodiments, the heated solvent solution corresponds to a condensed solvent solution and/or a heated condensed solvent solution. For example, in some implementations (as applied to removing all or substantially all colorant from the polyester material 101), the condensed solvent solution is heated to a temperature between about 95° C. and about 130° C. in association with the contacting and the duration of time is between about 2 minutes and about 60 minutes. In other implementations, as applied to removing all or substantially all of an optical brightener (or brightener agent), a perfluoroalkyl substance, and/or other additive components disclosed herein, the condensed solvent solution is heated to a temperature between about 95° C. and about 130° C. in association with the contacting and the duration of time of the contacting is between about 2 minutes and 24 hours. Additional details regarding the continuous flow reaction process are described with reference to FIGS. 6-11.

The polyester material 101 can include, but is not limited to, polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly dialkyl diesters such as poly(butylene succinate) (PBS) and poly(butylene adipate) (PBA), and combinations thereof. In some embodiments, the polyester material 101 processed in accordance with method 100 and other methods described herein comprises nearly 100% by mass of at least one of the aforementioned polyester materials. In other embodiments, the polyester material 101 may include or correspond to a blended or mixed polyester material comprising other types of materials, such as but not limited to, cotton and other cellulosic materials, nylons, polyurethanes, acrylics, silk, wool, polyethers, elastanes (e.g., spandex and other elastomers), and combinations thereof. For example, the blended or mixed polyester material may comprise between 30% and 99% by mass of at least one of the aforementioned polyester materials, with the remaining mass percentage composed of one or more of the other types of materials. In preferred implementations, polyeter material 101 comprises at least 40% by mass of PET.

In various embodiments, the polyester material 101 is in the form of a fabric material, a textile material, a cloth material, a fibrous material, a granulate, or the like. Hereinafter, the terms fabric material, textile material, cloth material, fibrous material, and the like are used interchangeably unless context warrants particular distinction amongst the terms. In other embodiments, the polyester material 101 may be in the form of bottle flake, a sheet, a dense granulate, pellet, or a molded article. Bottle flake refers to small flakes of plastic obtained from recycled plastic bottles, typically made of PET. These flakes are produced by shredding used plastic bottles into small pieces after cleaning and removing labels and caps.

In various embodiments, the one or more additive components of the polyester material 101 comprises a colorant, such as a dye (e.g., a disperse dye, a vat dye, a direct dye, a sulfur dye, a reactive dye, an acid dye, and/or a cationic dye), a pigment, an ink, and/or another type of colorant. For purposes of the present disclosure, “colorant” refers to any chemical substance, compound, mixture, pigment, dye, or coloration agent that imparts, modifies, enhances, or alters visible color, shade, hue, tint, tone, depth, or appearance of a textile material, including both coloration that is chemically bound to a fiber and coloration that is physically or mechanically adhered, applied, coated, or deposited on a fiber surface, unless context warrants particular distinction amongst the terms. The term colorant is intended to encompass all natural and synthetic dyes, pigments, inks, stains, tinting agents, and other chromophoric materials, whether water-soluble, solvent-soluble, dispersed, particulate, polymer-bound, or microencapsulated. In this regard, the terms “colorant,” “pigment,” “dye” and variations thereof, are used herein interchangeably, unless context warrants particular distinction amongst the terms.

In some embodiments, the colorant includes or corresponds to a dye or pigment that has a chromophore based on a variety of chemical functionality (e.g., Azo dyes, Anthraquinone dyes, benzodifuranone dyes, phthalocyanine dyes, violanthrone dyes, coumarin dyes, and the like). Generally, colorants used to dye polyester material are referred to as pigments. These colorants or pigments are deposited onto fibers of the polyester material as opposed to being chemically bonded thereto.

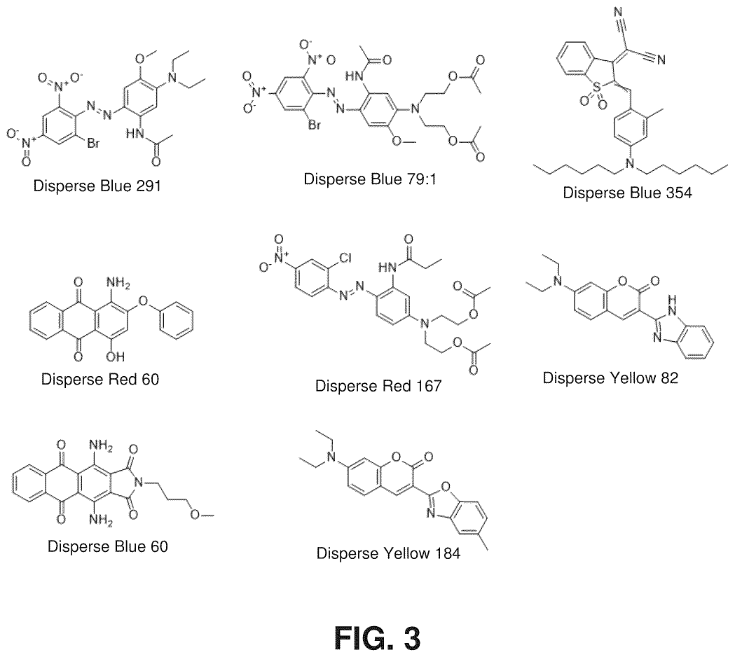

For example, FIG. 3 presents chemical structures of several example colorants capable of being removed from polyester material, in accordance with one or more embodiments described herein. The colorants illustrated in FIG. 3 are disperse dyes. In various embodiments, the polyester material 101 processed in accordance with method 100 and other methods described herein are colored polyester materials that have been dyed with one or more disperse dyes, such as those presented in FIG. 3. In accordance with these embodiments, method 100 and additional methods described herein can be adapted (e.g., as a function of temperature of the heated solution, concentration of the solvent, duration of contacting, number of repeated contacting steps, and other variables described herein) to remove all or substantially all of the colorant from the colored polyester material.

Dyeing polyester is more complex than dyeing natural fibers because polyester is a synthetic fiber with a hydrophobic (water-repelling) nature. To achieve deep and long-lasting colors, disperse dyes and high-temperature conditions (e.g., between about 110-130° C.) are typically used. Under this condition, the amorphous region of the polyester fiber becomes partially molecularly mobile and swellable, allowing dye molecules to disperse within the amorphous regions of the polyester fibers. In various embodiments, in accordance with method 100 and other methods described herein, to remove disperse dyes and other colorants from colored polyester material, the heated solution comprising the solvent is heated to a boiling point temperature of the solvent, wherein the boiling point temperature is lower than the melting point temperature of the polyester material. For example, in some embodiments, the solvent solution is heated to a temperature between about 66° C. to about 130° C. In other embodiments, the temperature may be increased or decreased based on the particular solvent used (e.g., cyclopentanone (CPO), cyclohexanone, 1,4-dioxane, 1,3-dioxolane, tetrahydrofuran, 2-methyl tetrahydrofuran, dimethyl carbonate, diethyl carbonate, ethyl lactate ethyl acetate and/or combinations thereof) and/or as a function of other aspects of method 100 (described herein) to remove a desired amount of the colorant from the colored polyester material. In some embodiments, the process is run under ambient atmospheric pressure. In another embodiment aspects of the process can be carried out at elevated pressure to increase the boiling point of the solvent, for example during the extraction step.

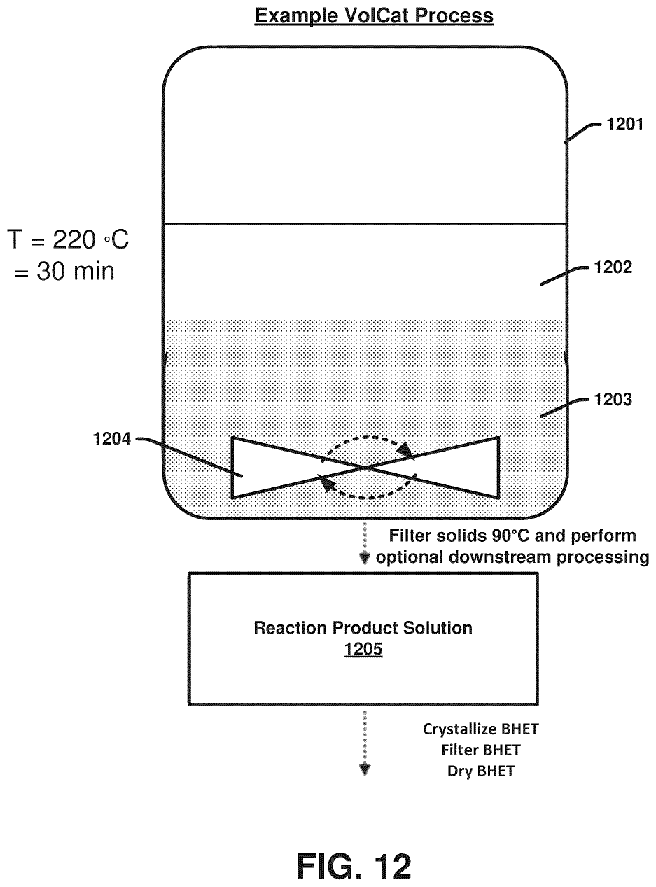

Additionally, or alternatively, the one or more additive components of the polyester material 101 processed in accordance with method 100 and other methods described herein can include, but are not limited to, a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt, grime, and combinations thereof. In this regard, in addition to colorant, method 100 and other methods described herein can also remove the additional aforementioned substances as integrated on or within the polyester material. The substances removed can include environmental and health hazards including azo dyes and byproducts (carcinogens and irritants), brominated flame retardants and polyfluoro- and perfluoro-alkyl substances (endocrine disruptors, carcinogens, neurotoxins, reproductive toxins and bioaccumulants). With these additional substances removed, the purified polyester material can be transformed into a higher quality recycled product via a glycolysis process (described with reference to FIG. 12) and other existing chemical and/or mechanical polyester recycling processes.

For example, per-and poly-fluoroalkyl (PFAS) substances are a group of synthetic chemicals that are sometimes added to polyester fabrics to provide waterproofing, stain resistance, and oil repellency. These chemicals were commonly used in outdoor gear, activewear, upholstery, and workwear due to their ability to repel liquids and resist degradation, but are being removed from use due to environmental and health concerns. Although their use is diminishing, these materials are nearly ubiquitous and are present in many polyester recycle streams. It is thus highly desirable to remove them from reentering use through a recycle stream such as polyester fabric.

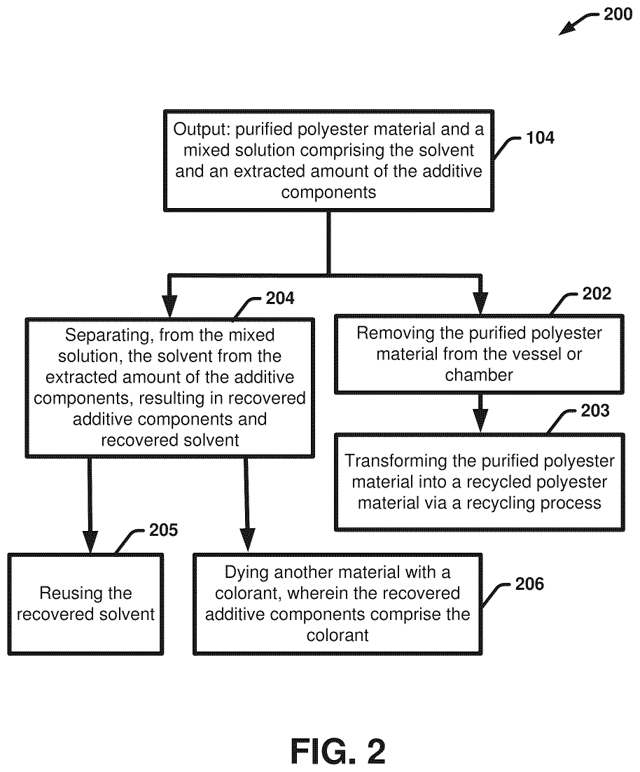

FIG. 2 illustrates a flow diagram of an example, non-limiting method 200 for recycling a polyester material in accordance with one or more embodiments described herein. The input to method 200 comprises the output 104 of method 100. Repetitive description of like elements employed in respective embodiments is omitted for sake of brevity.

At 202, method 200 comprises removing the purified polyester material from the vessel or chamber used in the extraction process of method 100. At 203, method 200 comprises transforming the purified polyester material into a recycled polyester material via a recycling process. The recycling process can vary and include any existing or future developed chemical and/or mechanical recycling processes used to recycle polyester material. In this regard, because the purified polyester material resulting from the disclosed methods is free or substantially free of colorant and/or other additive substances discussed herein, the purified polyester material can be efficiently transformed into a high quality recycled polyester material with minimal or no additional pre-processing or post-processing steps to remove colorant and/or the additive substances therefrom.

This high-quality polyester can then be processed into recycled material by mechanical or chemical recycling processes. Chemical recycling processes include hydrolysis or solvolysis processes such as methanolysis or glycolysis. One non-limiting example of a chemical recycling process that may use the purified polyester material of the disclosed methods is the volatile catalyst (VolCat) method described in U.S. Pat. No. 9,255,194 B2 to Allen et al. and U.S. Pat. No. 9,914,816 B2 to Allen et al. The VolCat process depolymerizes PET rapidly via glycolysis using an organocatalyst into the molecule Bis(2-hydroxyethyl)terephthalate (BHET), which can be repolymerized into a recycled polyester material. This process has drawn industrial interest due to its potential to valorize low-cost waste streams and divert a sizeable portion of polyester waste from landfills. The technology is well suited to process bottle flake inputs by extracting the PET component from other plastics and additives during the solution process. The VolCat process is less resilient against contamination from components found in textiles, such as increased amounts of colorants and other additive substances disclosed herein (e.g., lubricant agents, brightener agents, perfluoroalkyl substances, polyfluoroalkyl substances, scouring agents, anti-foam agents, leveling agents, wicking agents, and the like).

More particularly, the depolymerization of polyester by glycolysis with ethylene glycol has been found to proceed rapidly in the presence of an organocatalyst. For bottle flakes, the additives present are typically insoluble and filtered post-glycolysis. Due to the ease of sorting bottle flakes much of this feedstock is fit for mechanical recycling, especially as the capabilities of materials recycling/recovery facilities (MRFs) have increased. Currently, MRFs do not have the capacity to sort clothing for thermomechanical recycling, leaving waste PET clothing (i.e., PET fabric materials) outside the capabilities of the current recyclables market. However, these fabrics can be processed by chemical recycling. The challenge is most polyester fabrics contain increased amounts of dyes and other additive substances disclosed herein that are known to be detrimental to the quality of the monomer product obtained from chemical recycling processes such as VolCat. This places a burden on the downstream purification processes required to increase the quality of the monomer, which the disclosed techniques mitigate.

The disclosed methods thus provide the necessary pre-treatment step to remove colorant and other additive substances from PET and other polyester materials including fabric prior to depolymerization via glycolysis, thus greatly extending the application of the VolCat process and other textile polymer recycling process to textiles and fabrics currently being landfilled or incinerated.

At 204 method 200 further comprises separating, from the mixed solution, the solvent from the extracted amount of the additive components, resulting in recovered additive components and recovered solvent. For example, this can be accomplished via evaporation of the solvent from the mixed solution, resulting in isolation of the recovered additive components, and then recondensing the evaporated solvent into the recovered solvent. Additionally, or alternatively, the extracted amount of additive components may be separated from the solvent within the mixed solvent solution via filtration. At 205, method 200 further comprises reusing the recovered solvent. For example, the recovered solvent may be reused in another extraction process to extract additional additive components from the polyester material 101 or a new polyester material corresponding to polyester material 101. At 206, in implementations in which the recovered additive components comprise a colorant, method 200 can further comprise dying another material with the colorant.

FIG. 4 presents an example, non-limiting extraction system 400 for removing one or more additive components from a polyester material (e.g., polyester material 101) in accordance with one or more embodiments described herein. With reference to FIG. 4 in view of FIG. 1, extraction system 400 includes heating element 410 and a vessel 404 comprising an enclosure 402 (a lid or the like) and a stirring apparatus 408 (which may be removed in some implementations). In some embodiments, extraction system 400 can include or correspond to a high-pressure batch reactor, such as a Parr high-pressure batch reactor manufactured by the company Parr Instrument Company or a similar high pressure batch reactor adapted for processing large amounts of polyester material on an industrialized level. High-pressure batch reactors operate as a closed system, meaning inputs are loaded into the vessel and sealed before the extraction and products are removed after completion. In other embodiments, extraction system 400 can include or correspond to an open system (e.g., performed under ambient pressure). In some implementations, the stirring apparatus 408 can include or correspond to a magnetic or mechanical stirring apparatus. In other implementations, other means of mechanical agitation for uniform mixing of reactants may be used.

The heating element 410 can include or correspond to an electrical heater or external jacket that provides for precise temperature control and may include cooling coils for rapid temperature control adjustments. In some embodiments, the reaction system 400 can includes a gas introduction apparatus (not shown) that allows for controlled gas injection (e.g., nitrogen) for reactions requiring pressurized or inert gases.

As noted above, in some embodiments, the contacting of method 100 may be performed using extraction system 400 or a similar system. With these embodiments, the polyester material 101 is placed within the vessel 404 along with the solvent solution 406 and heated to a target temperature (via the heating element 410), preferably for a duration between about 1 minute and about 15 minutes. In some embodiments, the target temperature is preferably between about 50° C. and about 130° C. The duration of time and the target temperature can vary depending on the solvent used in the solvent solution 406 (e.g., which can include but is not limited to: cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate, and combinations thereof), the type of additive component or components to be removed from the polyester material 101 (e.g., which can include, but is not limited to: a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime), the concentration of additive components included in the polyester material, and the type of the polyester material (e.g., polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly(butylene succinate) (PBS), poly(butylene adipate) (PBA) and other poly dialkyl diesters, and/or polyalkalene alkanoates).

In addition, depending on these factors, in some embodiments, the extraction process may be performed over multiple (e.g., two or more iterations) using fresh solvent solution after removing the solvent used in the previous iteration. For example, in accordance with one or more embodiments, the contacting of method 100 may be performed over multiple (e.g., two or more) iterations using fresh solvent solution and extraction system 400 (or a similar extraction system).

In this regard, in one or more embodiments, colorant and other additive components may be removed from the polyester material 101 using extraction system 400 (or a similar system) and Extraction Process 1, as described below.

### Extraction Process 1

Step 1. Place the polyester material 101 and the solvent solution 406 within the vessel 404 (which may be optionally pressurized).
Step 2. Heat the solvent solution to a target temperature for a defined duration of time via the heating element 410 (while optionally stirring via stirring apparatus 408) to extract at least some of the additive components from the polyester material 101, which become dispersed within the solvent solution (e.g., resulting in a mixture within the vessel 404 comprising the solvent and an extracted amount of additive component(s)).
Step 3. Remove the (mixed) solvent solution and/or the polyester material from the vessel.
Step 4. (Optionally) Repeat Steps 1-3 one or more additional times using fresh solvent solution added to the vessel 404.

In some embodiments of Extraction Process 1, the target temperature at Step 1 of Extraction Process 1 is between about 50° C. and about 160° C. and the duration of time is between about 1 minute to about 60 minutes. In other embodiments, the target temperature is between about 70° C. and about 130° C. and the duration of time is between about 1 minute to about 15 minutes. Still in other implementations, the target temperature is between about 70° C. and about 100° C. and the duration of time is between about 1 minute to about 10 minutes. In an example embodiment in which the solvent comprises cyclopentanone and the additives to be removed from the polyester material 101 comprise a colorant such as a disperse dye, the target temperature at can range between about 70° C. and about 100° C., and the duration of time can range as low as between about 1 minute and about 2.5 minutes. It should be appreciated however that the particular temperature and duration of heating can vary depending on the particular solvent used, the concentration of the solvent relative to the amount of the polyester material, and the amount and type of additives to be removed from the polyester material.

In some embodiments of Extraction Process 1, the extracted additives included in the mixed solvent solution are optionally recovered therefrom (e.g., via evaporation of the solvent solution, or another mechanism). For example, in some implementations, colorant (and/or other additives) included in the mixed solvent solution can be recovered therefrom via evaporation (e.g., vacuum evaporation using a rotary evaporator, distillation, flash distillation, spray drying, or the like) of the solvent out of the mixed solvent solution as provided in a vessel, leaving colorant remaining in the vessel. The recovered colorant may further be used to dye another material. In addition, the distilled solvent solution with the additives removed therefrom becomes a purified solvent, which may be reused in subsequent extraction cycles. For example, in some implementations, the fresh solvent solution at Step 4 of Extraction Process 1 includes or corresponds to fresh solvent solution formed with the purified solvent.

In some implementations, Steps 1-3 of Extraction process 1 may be performed once (e.g., depending on the concentration and amount of additive components desired to be removed from the polyester material). In other embodiments, Steps 1-3 may be repeated one or more times, wherein each iteration removes an additional amount of additive components. The number of repetition times can vary depending on the type and mass percentage of additive components to be removed from the polyester material 101 and the desired amount of the additive components to be removed. The number of repetitions can also vary depending on the particular solvent used, the concentration of the solvent in the solvent solution relative to the amount of polyester material, the heating temperature and the defined duration of contact time while heating. In some embodiments, as applied to removing colorant, Steps 1-3 can be performed repeatedly (with fresh solvent solution) until no colorant is visually observable in the purified polyester material.

In an example experimental implementation of Extraction Process 1, (hereinafter Experiment 1), various disperse dyes (e.g., those shown in FIG. 3 and others) were removed from 12 different PET fabric samples under the following conditions.

### Experiment 1

The respective PET fabric samples were about 2 grams (g) in mass and contained up to 7% weight of a disperse dye, rendering them visibly richly colored in variations of black, red, blue, and yellow prior to processing. The respective samples were added to a 450 milliliter (mL) pressurized vessel with a solvent solution comprising 250 g of the solvent CPO. The mixture was heated to a temperature of about 100° C. for a period of time of about 2.5 minutes. Thereafter, the contaminated solvent solution was removed from the vessel. This process was repeated three times (each time with fresh solvent solution) in order to remove all visible colorant from the PET fabric samples, rendering them visibly white. The colorant removed after each repetition was recovered from the contaminated solvent solution and analyzed. The amount of disperse dye removed after the first repetition was 1.8%, the amount of additional disperse dye removed after the second repetition of process was 0.8%, and the amount of even more additional colorant removed after the third repetition was 0.6%.

FIG. 5 presents the 12 different polyester fabric samples before and after colorant removal in accordance with Experiment 1. The fabric samples before colorant removal are respectively positioned on their decolored versions. As can be seen in FIG. 5, each of the different fabric samples changed from their highly pigmented color to a white or substantially white color following performance of Experiment 1.

With reference again to FIG. 4, in one or more alternative embodiments, colorant and other additive components may be removed from the polyester material 101 in about 3 minutes using extraction system 400 (or a similar system) and Extraction Process 2, as described below.

### Extraction Process 2

Step 1. Place the polyester material 101 and the solvent solution 406 within the vessel 404 (which may be optionally pressurized).
Step 2. Heat the solvent solution to 130° C. for about 2 minutes (while optionally stirring via stirring apparatus 408) to extract at least some of the additive components from the polyester material 101, which become dispersed within the solvent solution (e.g., resulting in a mixture within the vessel 404 comprising the solvent and an extracted amount of additive component(s)).
Step 3. Remove the processed polyester material from the vessel and filter excesses contaminated solvent solution therefrom (e.g., via vacuum filtration or another mechanism).
Step 4. Dip or rinse (e.g., for a duration between about 1 second and about 10 seconds) the filtered polyester material in a fresh solvent solution that has been preheated to a temperature of 130° C.

In an example experimental implementation of Extraction Process 2, (hereinafter Experiment 2), various disperse dyes (e.g., those shown in FIG. 2 and others) were removed from different PET fabric samples under the following conditions.

### Experiment 2

The combined PET fabric samples totaled about 0.82 g in mass and contained up to 7% weight of a disperse dye, rendering them visibly richly colored in variations of black, red, blue, and yellow prior to processing. The respective samples were added to a 40 mL vessel equipped with a stirring apparatus. A solvent solution comprising 8.2 g of the solvent CPO was added to the vessel and the mixture was heated to a temperature of about 130° C. for a period of time of about 2.0 minutes. The wet fabric was then removed, vacuum filtered and pressed to remove any solvent solution. Next, fresh solvent solution comprising 8.2 g of the solvent CPO was added to a new vessel and heated to a temperature of about 130° C. The filtered fabric samples were then quickly dipped into the hot solvent solution as a hot wash step, then removed, vacuum filtered and pressed as before. The resulting purified fabric samples were then gently dried with a heat gun (e.g., using about 200° C. air). All resulting fabric samples were visibly white and provided comparable results as those illustrated in FIG. 5.

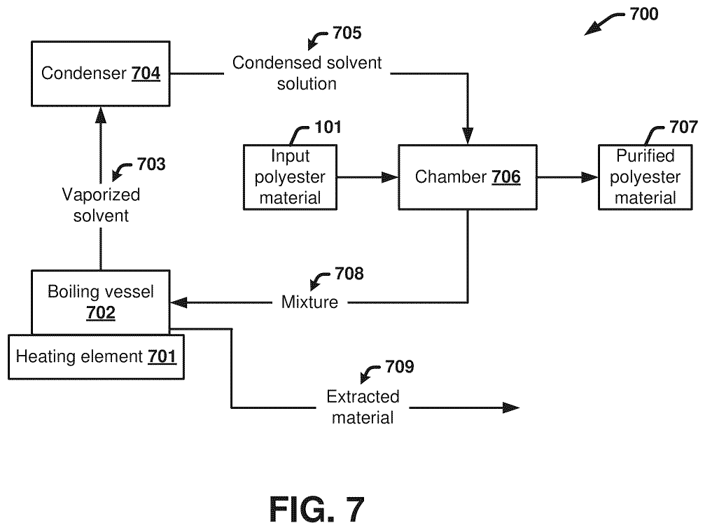

FIG. 6 illustrates a flow diagram of another example, non-limiting method 600 for removing one or more additive components from a polyester material in accordance with one or more embodiments described herein. Method 600 corresponds to an embodiment of method 100 wherein the contacting of method 100 is performed using a continuous flow reaction system. Examples of the continuous flow reaction system that can be used for method 600 are presented in FIGS. 7, 9, 10 and 11 and described in greater detail infra. The input to method 100 includes polyester material 101. Repetitive description of like elements employed in respective embodiments is omitted for sake of brevity.

At 601, method 600 comprises placing the polyester material 101 in a chamber of a continuous flow reaction system for a duration of time. At 602, method 600 comprises performing an extraction process over the duration of time using the continuous flow reaction system, wherein the reaction process comprises contacting a condensed solvent solution comprising a solvent to the polyester material as positioned within the chamber, wherein the solvent is selected from the group consisting of: a ketone, an ether, an ester, an alcohol and a carbonate. For example, as noted above, the solvent can include, but is not limited to: CPO, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and/or ethyl acetate. At 603, method 600 comprises removing at least some of the one or more additive components from the polyester material as a result of the performing, resulting in a transformation of the polyester material into the purified polyester material (e.g., wherein the purified polyester material excludes at least some of the one or more additive components).

In various embodiments, the output of method 600 corresponds to the output of method 100 (e.g., output 104). In this regard, the output of method 600 includes a purified polyester material that excludes at least some of the additive components. The output of method 600 can also include the mixed solvent solution, as described in greater detail below. In this regard, in various embodiments, method 200 can also be applied to the output of method 600.

FIG. 7 illustrates an example continuous flow reaction system (hereinafter system 700) in accordance with one or more embodiments described herein. System 700 includes, but is not limited to, heating element 701, boiling vessel 702, condenser 704, and chamber 706. The actual implementation of system 700 can vary with respect to the physical arrangement and size of these components so long as they are respectively connected to one another via suitable conduits (aside from the heating element 701 which is merely coupled to the boiling vessel 702). In this regard, it should be appreciated that the boiling vessel 702 is connected to the condenser 704 via a suitable conduit, the condenser 704 is connected to the chamber 706 via a suitable conduit, and the chamber 706 is connected to the boiling vessel 702 via a suitable conduit. For example, in some embodiments, system 700 may include or correspond to a Soxhlet extractor or a variation thereof as adapted for industrial processing of vast amounts of polyester material corresponding to polyester material 101.

With reference to FIG. 7 in view of FIG. 6, as indicated via the arrowed lines, FIG. 7 also provides a high-level view of the flow of the extraction process performed at 601, (hereinafter, Extraction Process 3) in accordance with one or more embodiments. Extraction process 3 is performed repeatedly or continuously. In this regard, in association with initiation of Extraction Process 3, the polyester material 101 is placed within the extraction chamber 706. As described in greater detail below, in some embodiments, this can involve continuously or regularly feeding in polyester material 101 into the chamber 706 (e.g., via a mechanical conveyance or another mechanism), maintaining the polyester material 101 therein for a duration of time in association with contacting a condensed solvent solution 705 thereto within the chamber 706 to extract (at least some of) the additive components therefrom, thereby transforming the polyester material into purified polyester material 707 (which excludes at least some of the additive components), and removing the purified polyester material 707 from the chamber 706 after the duration of time (e.g., via mechanical conveyance or another mechanism).

In this regard, over the duration of time in which the polyester material 101 is maintained within the chamber 706, Extraction Process 3 comprises repeatedly or continuously heating the boiling vessel 702 via heating element 701 to transform solvent included in fresh solvent solution or a mixture (e.g., mixture 708) within the boiling vessel 702 into a vaporized solvent 703. As with previous methods, the solvent can include cyclopentatnone, cyclohexanone, 1,4-dioxane, 1,3-dioxolane, tetrahydrofuran, 2-methyl tetrahydrofuran, dimethyl carbonate, diethyl carbonate, ethyl lactate and/or ethyl acetate. The heating temperature of heating element 701 can correspond to the boiling point of the solvent used, which can vary. For example, the boiling point of the optional solvents disclosed herein (e.g., cyclopentatnone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate) ranges from about 66° C. to about 130° C. The (hot) vaporized solvent 703 travels into the condenser 704 where it is condensed and transformed into the condensed solvent solution 705. The condensed solvent solution 705 is directed into the chamber 706 where it contacts the polyester material 101 therein and extracts or otherwise removes the additive component(s) therefrom, forming a mixture 708 comprising the solvent and an extracted amount of the additive components. The mixture is 708 is further directed out of the chamber 706 and into the boiling vessel 702. In some embodiments, the mixture 708 may be directed out of the chamber 706 and into the boiling vessel 702 at a controlled rate. For example, the mixture 708 may be slowly leaked out of the chamber 706 as new condensed solvent solution 705 enters the chamber 706 in a continuous manner. In another implementation, an entirety of the mixture 708 within the chamber 706 may be flushed out of the chamber 706 regularly at a defined rate. In either implementations, the mixture 708 is directed out of the chamber 706 where it is reheated to transform the solvent therein back into the vaporized solvent 703, which is again directed to the condenser 704 where it is transformed into the condensed solvent solution 705, which is further directed into the extraction chamber 706 where it extracts additional additive components therefrom and forms (additional) mixture 708, which is then directed into the boiling vessel 702, and so on. System 700 and Extractin Process 3 thus not only effectively removes colorant and other additive components from the polyester material 101 and transforms it into purified polyester material 707 but also reuses the same solvent over and over.

In this regard, Extraction Process 3 is performed on continuous loop over the duration of time while the polyester material 101 is maintained within the chamber 706. The duration of time refers to the amount of time the polyester material 101 is maintained within the chamber 706 and exposed to condensed solvent solution 705. The duration of time can be adapted based on the desired amount of additives to be removed, the type of additives, the concentration of the additives, the temperature of the condensed solvent solution 705 (which may be controlled, as described infra), and the particular solvent used. The duration of time can also be tailored as a function of the rate of evaporation of the solvent, the rate of condensation of the vaporized solvent, and the rate and amount of influx of condensed solvent solution 705 into the chamber 706, the size of the chamber, and the like, which can vary based on the architecture of system 700. Extraction process 3 may also continue to be performed on a continuous loop over sequential durations of time as new polyester material (e.g., corresponding to polyester material 101) is regularly or continuously fed into the chamber 706 and purified polyester material 707 is regularly or continuously removed from the chamber 706. The purified polyester material 707 can further be recycled in accordance with method 200. For recycling purposes, the purified polyester material 707 can be further dried of residual extraction solvent for example via heated vacuum oven with the solvent optionally recovered for reuse in subsequent extractions.

In association with heating the mixture 708 included in the boiling vessel 702, the solvent is vaporized out of the mixture 708 and transformed into the vaporized solvent 703 resulting in aggregation of the extracted additive components (also referred to as the extracted material 709) within the boiling vessel 702 over time (e.g., in a solid or particulate form). In various embodiments, the extracted material 709 can be removed from the boiling vessel, recovered (e.g., via evaporation and/or filtration) and reused (e.g., to dye another material in implementations in which the extracted material 709 includes a colorant). The manner and timing at which the extracted material 709 is removed from the boiling vessel 702 can vary.

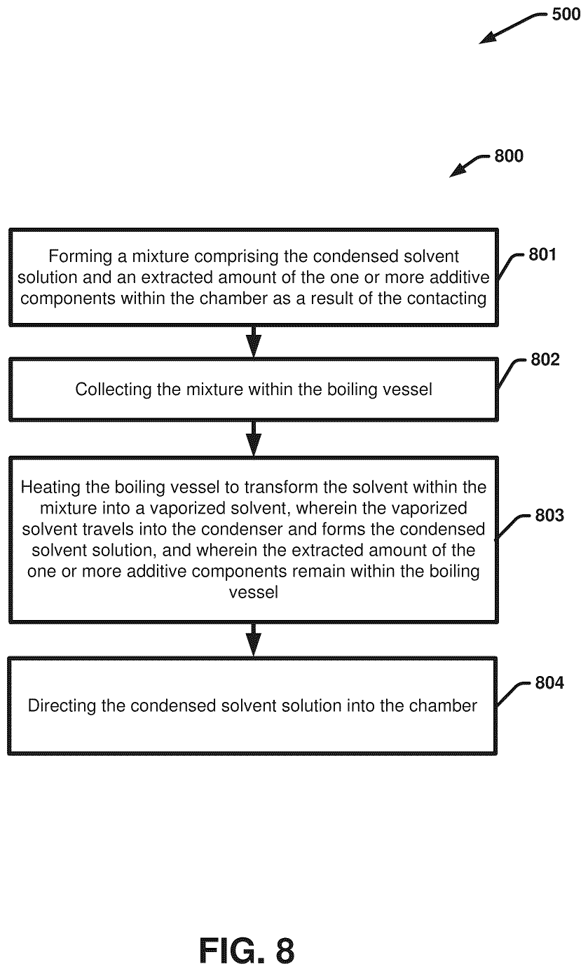

FIG. 8 illustrates a flow diagram of an example continuous flow extraction process (hereinafter extraction process 800) using continuous flow reaction system 700. In this regard, extraction process 800 can include or correspond to Extraction Process 3. In various embodiments, extraction process 800 corresponds to the extraction process performed at 602 of method 600. Extraction process 800 comprises repeatedly or continuously performing each of steps 801-804 over the duration of time in which the polyester material 101 is maintained within the chamber 706. At 801, extraction process 800 comprises forming a mixture (e.g., mixture 708) comprising the condensed solvent solution (e.g., condensed solvent solution 705) and an extracted amount of the one or more additive components within the chamber (e.g., chamber 706) as a result of the contacting. At 802, extraction process 800 comprises collecting the mixture within the boiling vessel (e.g., boiling vessel 702). At 803, extraction process 800 comprises heating the boiling vessel to transform the solvent within the mixture into a vaporized solvent (e.g., vaporized solvent 703), wherein the vaporized solvent travels into the condenser and forms the condensed solvent solution 705, and wherein the extracted amount of the one or more additive components remain within the boiling vessel. At 804, extraction process 800 comprises directing the condensed solvent solution into the chamber.

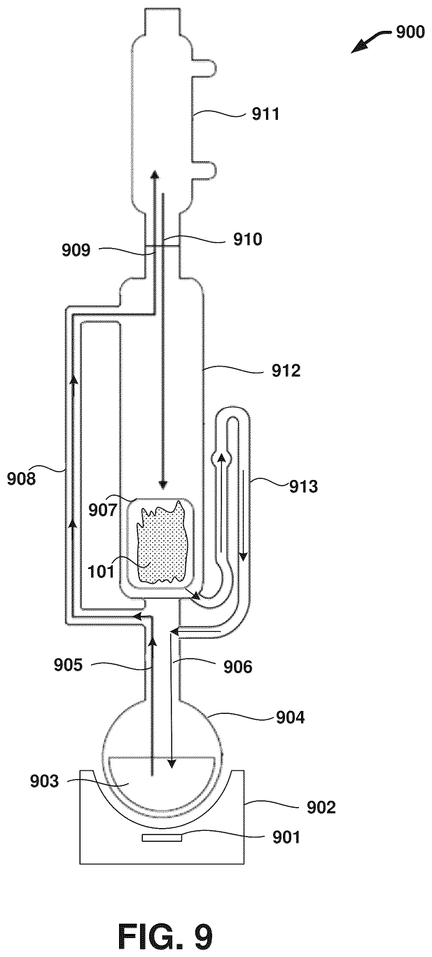

FIG. 9 illustrates another example continuous flow reaction system (hereinafter system 900) in accordance with one or more embodiments described herein. System 900 corresponds to an embodiment of system 700. In accordance with this embodiment, system 900 includes or corresponds to a Soxhlet extraction system.

System 900 includes a boiling vessel 904 (e.g., corresponding to boiling vessel 702),

a condenser 911 (e.g., corresponding to condenser 704), a side arm 908 connecting the boiling vessel 904 to the condenser 911, a chamber 912 (e.g., corresponding to chamber 706), a siphon arm 913 connecting the chamber 912 to the boiling vessel 904, and a heating element 902 positioned below the boiling vessel 904 (e.g., corresponding to heating element 701).

Upon initial operation, (fresh) solvent solution 903 (comprising one or more of the disclosed solvents) is placed in the solvent boiling vessel 904, and the polyester material 101 is placed in the chamber 912. In some embodiments, the chamber 912 can include removable a thimble 907 or basket formed of a porous, heat-resistant material, which holds the polyester material 101 and allows hot, condensed solvent solution to pass therethrough. The solvent solution 903 in the boiling vessel 904 is heated to the solvent boiling point temperature in order to vaporize the solvent via the heating element 902. The heating element 902 can include a thermocouple 901 to monitor and/or control the temperature to which the solvent solution 903 is heated. Once the solvent has vaporized, the solvent vapor travels from the boiling vessel 904 to the condenser 911 via the side arm 908, as indicated via arrows 905 and 909. In this regard, it should be appreciated that a first opening is provided between the boing vessel 904 and the side arm 908 that connects the boiling vessel 904 to the side arm 908, and a second opening is further provided between the side arm 908 and the condenser 911 that connects the side arm 908 to the condenser 911.

Within the condenser 911, the vapor (e.g., vaporized solvent 703) condenses into a liquid (referred to herein as a “condensed solvent solution,” (e.g., condensed solvent solution 705) “condensed solvent” or “condensate”) that drips from the condenser 911 into the chamber 912 via gravity (as indicated via arrow 910). In this regard, it should be appreciated that an opening is provided between the condenser 911 and the chamber 912 that connects the condenser 911 to the chamber 912. The condensed solvent solution thus slowly fills the chamber 912 where it contacts the polyester material 101 and extracts (some of) the one or more additive components therefrom and forms a mixture with condensed solvent solution (e.g., mixture 708 comprising solvent and extracted material 709). An optional embodiment is to have the polyester be subjected to a bath or baths of extraction solvent along its conveyance to improve extraction efficiency. In one implementation of system 900, this may be facilitated via a siphon arm 913, which periodically causes extraction chamber 912 to partially fill with the extraction solvent to the level of the top of the siphon tube, after which the mixture is further directed back into the boiling vessel 904 via the siphon arm 913 automatically (as indicated via arrow 906) at a rate controlled as a function of the siphon level and reflux rate of the condenser 911. In some implementations, the amount of the condensed solvent solution relative to the amount of the polyester material 101 maintained within the chamber over the reaction process is about 1 part by mass to about 10 parts by mass.

In various embodiments, the evaporation-condensation-extraction is repeated in a continuous loop for a duration of time until the polyester material 101 is free of color and/or other contaminants or additives, at which time, it becomes a purified polyester material (e.g., corresponding to purified polyester material 707). As noted above, this duration of time can vary based on multiple factors. The purified polyester material is then removed from the chamber 912 and the heating element 902 is turned off. In addition, the mixed solvent solution remaining in the solvent boiling vessel 904 can be reused until such time that the residue is recovered by evaporation and/or filtration to separate the solvent from the extracted material (e.g., colorant and/or other additive components discussed herein), where the former may be reused in additional solvent extractions and the latter may be reused to dye new materials (e.g., as applied to colorant).

In various embodiments, as applied to removing disperse dyes (e.g., those shown in FIG. 3 and others) from colored polyester fabric material using CPO as the solvent and wherein the colored polyester fabric contains up to about 7% mass of disperse dye, the duration of time required to remove all or substantially all colorant form the colored polyester fabric via system 900 (e.g., rending the purified fabric white or substantially white) ranges from between about 0.2 hours to about 1.0 hour. With these embodiments, (as described infra with reference to Experiment 4), under these conditions, the resulting purified fabric material comprises little to no disperse dye remaining therein (e.g., less than 2% mass of disperse dye remaining in some embodiments and less than 1% mass of disperse dye remaining in other embodiments).

In other embodiments, as applied to removing one or more other substances from the polyester material (in the form of a fabric material) using CPO as the solvent, including, but not limited to, a lubricant agent, a brightener agent, a perfluoroalkyl substance, a polyfluoroalkyl substance, a scouring agent, an anti-foam agent, a leveling agent, an antistatic compound, a water repellent, an emulsifier, and a wicking agent, wherein the polyester fabric contains up to about 7% mass of the one or more other substances, the duration of time required to remove all or substantially all of the one or more other substance via system 900 (e.g., rending the purified fabric white or substantially white) ranges from between about 10 minutes to about 24 hours. With these embodiments, (as described with reference to Experiment 5 below), under these conditions, the resulting purified fabric material comprises little to none of the other additive components remaining therein (e.g., less than 2% mass in some embodiments and less than 1% by mass in other embodiments).

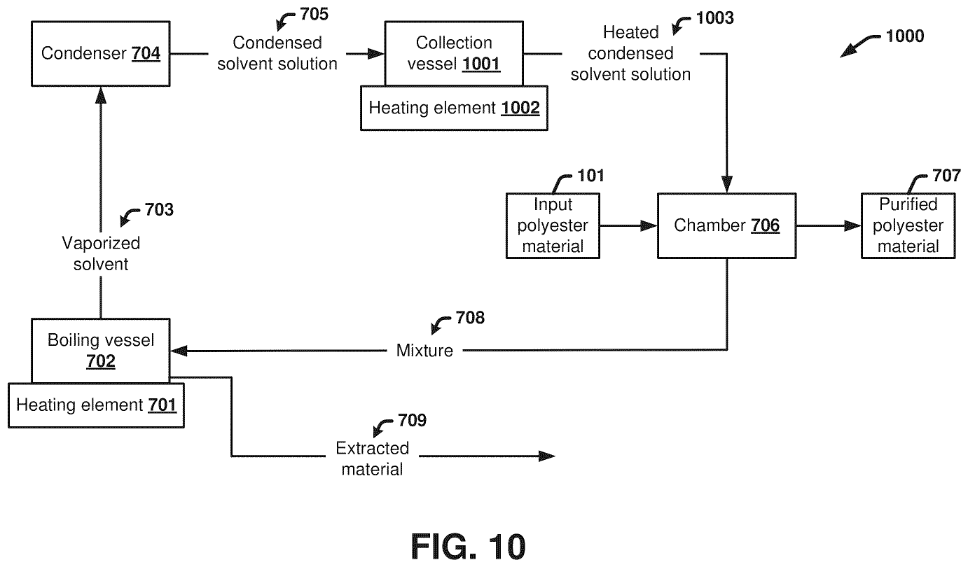

FIG. 10 illustrates another example continuous flow reaction system (hereinafter system 1000) in accordance with one or more embodiments described herein. System 1000 corresponds to system 700 as modified to increase efficiency. Repetitive description of like elements employed in respective embodiments is omitted for sake of brevity. In accordance with this embodiment, system 1000 includes a collection vessel 1001 and another heating element 1002 positioned between the condenser 704 and the extraction chamber 706. The collection vessel 1001 collects the condensed solvent solution 705 which is heated therein by the heating element 1002 to an increased temperature, thereby transforming the condensed solvent solution into heated condensed solvent solution 1003 which is directed into the chamber 706. In other words, in some embodiments, the condensed solvent solution 705 may be heated prior to being directed into the chamber 706. Additionally, or alternatively, the chamber 706 may be heated via another heating element (not shown), to increase the temperature of the condensed solvent solution therein. In either of these embodiments, the temperature of the heated condensed solvent solution 1003 is increased relative to the temperature of the solvent solution 705, which increases extraction efficiency (e.g., in terms of reducing contact time or exposure duration between the polyester material 101 and the condensed solvent solution and in terms of the amount of additive components extracted). In this regard, in some embodiments, a modification to Extraction Process 3 described above can comprise heating the condensed solvent solution 705 prior to introduction into the chamber 706. In other embodiments, another modification to Extraction Process 3 described above can comprise heating the chamber 706 and the condensed solvent solution therein.

In some implementations, the temperature to which the condensed solvent solution is heated prior to being directed into the chamber 706 and/or while inside the chamber 706 can vary depending on the boiling point of the particular solvent used of amongst the disclosed solvents and the solubility of the additive component or components to be extracted from the polyester material. In some implementations, the temperature is greater than or equal to the boiling point of the solvent. For example, the temperature may range between about 66° C. to about 130° C. In other implementations, the temperature may be between about 100° C. to about 140° C. In embodiments in which the polyester material contains PET, the temperature is preferably between 100° C. to about 130° C., as PET dissolution begins around 140° C. and about 150° C.

In another embodiment, instead of the chamber 706 being a static chamber, the chamber 706 may include a mechanical conveyance apparatus (hereinafter referred to as a “conveyor”), such as an auger, screw, internal or external helix or spiral, paddle or belt screw, helix, spiral, paddle or belt which moves the initial polyester material 101 into and through the chamber 706 and removes the purified polyester material 707 out of the chamber following completion of the extraction process. In some embodiments, the heated condensed solvent solution 1003 (or the condensed solvent solution 705) may be gravity fed into the chamber 706. In another embodiment, the heated condensed solvent solution 1003 (or the condensed solvent solution 705) may may be pumped into the chamber 706. For example, the heated condensed solvent solution 1003 (or the condensed solvent solution 705) is pumped into the chamber 706 in a counter-current flow compared to the flow of the conveyed polyester material. In all embodiments, the temperature and feed rates of the heated condensed solvent solution 1003 (or the condensed solvent solution 705) and the polyester material 101 should be balanced so that the residence time of the polyester material within the chamber 706 is sufficient for maximum, optimal extraction of the desired additive components (e.g., colorant and/or other additive substances discussed herein).

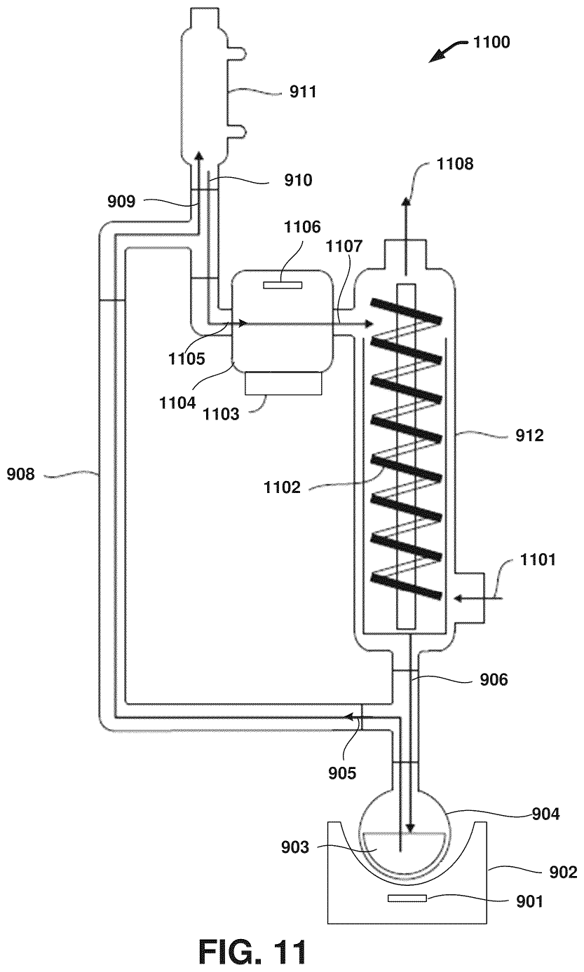

In this regard, FIG. 11 illustrates another example continuous flow reaction

system (hereinafter system 1100) in accordance with one or more embodiments described herein. System 1100 corresponds to an embodiment of system 1000. In accordance with this embodiment, system 1100 includes or corresponds to system 900 yet modified to increase extraction efficiency as described above. Repetitive description of like elements employed in respective embodiments is omitted for sake of brevity.

In accordance with this embodiment, chamber 912 includes an inlet opening 1101 via which input polyester material (e.g., polyester material 101) may be fed into the chamber 912 and an outlet opening 1108 via which reacted or purified polyester material (e.g., purified polyester material 707) may be removed from the chamber 912. In some implementations, the polyester material may be manually fed into the inlet opening 1101. In other implementations, another mechanical conveyance apparatus may be used to feed the polyester material into the inlet opening 1101. The chamber 912 also includes a conveyor 1102 (such as an auger, screw, internal or external helix or spiral, paddle, belt or another mechanical conveyance apparatus) that conveys the polyester material in a countercurrent direction (relative to the flow of the condensed solvent solution in into the chamber as illustrated) through the chamber 912 and carries it out through the outlet opening 1108 once the desired amount of additives have been removed therefrom. With this embodiment, new (uncleaned) polyester material may be continuously fed into the chamber 912 as reacted polyester material is removed therefrom, optionally over the duration of the reaction process.

System 1100 also includes a collection vessel 1104 (e.g., corresponding to collection vessel 1001) positioned between the condenser 911 and the chamber 912, and a heating element 1103 (corresponding to heating element 1002) coupled to the collection vessel 1104. In operation, the condensed solvent solution (e.g., condensed solvent solution 705) flows from the condenser 911 into the collection vessel 1104 (as indicated via arrow 1105) where it is heated via heating element 1103, and then out of the collection vessel 1104 and into the chamber 912 (as indicated via arrow 1107. In some implementations, a solvent pump may be integrated on or within the collection vessel 1104 to pump the heated condensed solvent solution out of the collection vessel and into the chamber 912. A thermocouple 1106 may also be integrated on or within the collection vessel 1104 to control and monitor the temperature of the heated, condensed solvent solution.

In this regard, although the solvent solution is heated in the boiling vessel 904 via heating element 902, after it evaporates and condenses via the condenser 911, the temperature of the resulting condensed solvent solution decreases. For example, assuming the solvent vapor leaves the boiling vessel at or near its boiling point temperature (e.g., about 130° C. as applied to cyclopentatnone), the temperature of the condensed solvent solution becomes lower than the boiling point temperature. In some embodiments, in order to increase extraction efficiency, the heating element 1103 can heat the condensed solvent solution to increase the temperature of the condensed solvent solution to a target temperature prior to introduction therein into the extraction chamber 912, such equal to its boiling point temperature, nearer to its boiling point temperature, or higher than its boiling point temperature in the portions of the process flow that may be pressurized. Additionally, or alternatively, another heating apparatus may be positioned on, around, or within the chamber 912 to heat the condensed solvent solution and contents within the extraction chamber 912.

The countercurrent flow of the conveyor 1102 (e.g., an auger or other form of conveyance) transports the polyester material in one direction and the clean, regenerated condensed solvent in the opposite direction, thus ensuring a maximal amount of the surface area of the polymeric material to encounter the condensed solvent solution as well as continued reuse of the solvent solution by distillative purification. As with system 700, system 900 and system 100,0 the evaporation-condensation-extraction loop of system 1100 continues as an uninterrupted conveyance. When the polyester material has been sufficiently exposed to the condensed solvent solution, the purified polyester material is removed from the chamber 912 (e.g., via outlet opening 1108). Alternatively, new, (unreacted) polyester material may be introduced into the chamber 912 in a counterflow direction where a conveyance introduces additional feedstock while the purified (e.g., decolored or the like) polyester material is conveyed away from the chamber 912 for recovery. In some embodiments, the solvent remaining on the purified polyester material is further removed by drying and evaporation and this solvent is then reintroduced into the process solvent flow and the dried polyester material further processed into recycled product. The extraction process performed using system 1100 is thus a continuous flow with respect to the solvent usage as well as the processing of input polyester feedstock. In some embodiments, solvent in the vessel 904 can be periodically replenished with new solvent to make up for any losses during operation.

FIG. 12 illustrates an example glycolysis process for transforming a purified polyester material into a recycled polyester material, in accordance with one or more embodiments described herein. In various embodiments, this glycolysis process corresponds to the aforementioned VolCat process. As illustrated in FIG. 12, the example glycolysis process involves placing the purified polyester material 1203 within an optionally pressurized vessel 1201 within a solvent solution 1202 comprising an alcohol such as ethylene glycol and an organocatalyst. The purified polyester material 1203 can include or correspond to any of the purified polyester materials described herein or otherwise generated via the methods disclosed herein. In a preferred embodiment, the purified polyester material contains at least 40% by mass of PET and has been filtered to remove any solvent solution therefrom which was used for the colorant and/or additive removal (e.g., as such solvent may degrade the VolCat product). The pressurized vessel 1201 may include or correspond to the vessel that is part of a high-pressure batch reactor, such as a Parr high-pressure batch reactor manufactured by the company Parr Instrument Company or a similar high pressure batch reactor, as described with reference to FIG. 4. The reactor can also be a flow reactor such as an CSTR reactor, an auger, or other screw type reactor such as an extrusion reactor. The pressurized vessel is then heated to a temperature of about 220° C. for a duration of about 30 minutes while stirring via a stir bar 1204 (or another mechanical mixing device). Thereafter, the reaction product is cooled to around 90° C. and any solids (aside from BHET) are filtered out of the reaction mixture, leaving a reaction product solution 1205 comprising BHET, which can optionally be subjected to additional downstream finishing processes to further increase the quality of the products. For example, after further cooling, the BHET is then precipitated and filtered out of the reaction product solution 1205 and dried. In various embodiments, because the purified polyester material 1203 excludes or substantially excludes colorant and/or other additives disclosed herein, the resulting reaction products including BHET obtained also excludes or substantially excludes colorant and/or other additives, and use of the purified polyester material thereby minimizes or eliminates the burden on the otherwise costly downstream processes.

### Continuous Flow System Experiments

In example experimental implementations of method 600 using system 900, various disperse dyes (e.g., those shown in FIG. 3 and others) and other additive components were removed from different PET fabric samples under the following Experiments 3-5.

### Experiment 3

Materials: PET fabric dyed using an anthroquinone-based black dye was used as the colored polyester material for dye removal study using a range of different solvents. The solvents included: 1,4-dioxane (99.8%, Sigma-Aldrich), cyclopentanone (CPO), ≥99%, Sigma-Aldrich), 1,3-dioxolane (99.5+%, Thermo scientific), ethyl lactate, chloroform (≥99.8%, Avantor), diethyl carbonate (99%, Thermo scientific), toluene (≥99.9%, Supelco), tetrahydrofuran(≥99.9%, Supelco), dimethyl carbonate (99%, Thermo scientific), acetonitrile (≥99.9%, Supelco), and tert-butyl acetate (99%, Thermo scientific).

Extraction Process: The dye extraction was performed separately for each of the solvents. Each extraction process for the respective samples was performed using system 900 with the chamber 912 having a size of 375 mL. A 1.0 liter (L) round bottom flask was used for the boiling vessel 904, a heating mantle for the heating element 902, and a Allihn Condenser (PYREX™) for the condenser 911, with the chamber 912 wrapped with glass wool and foil for thermal insulation. The fabric samples were placed in a thimble and situated therein to assure the sample remained below the refluxed liquid level during extraction. The thimble was then loaded into the chamber and the condenser was attached with a thermocouple in the chamber to detect the temperature of the condensed solvent solution therein (referred to as the inner temperature). About 500 ml of fresh solvent solution was added to the round bottom flask, which was also equipped with a magnetic stir bar. The heating mantle was then placed under the round bottom flask with a thermocouple embedded between for temperature control (referred to herein as the outer temperature). The outer temperature was set to maintain reflux of the respective solvents. The ability to remove the dyes varied somewhat due to a variety of factors including the inner temperature within the chamber 912, which was determined by the boiling points of the respective solvent (with some temperature reduction due to the condensation process). The extraction times were each performed beyond the minimum required to decolor the fabric to assure the endpoint in color removal had occurred and for convenience (not optimized), which was approximately 8 hours. After this time the heating was removed and the fabric was removed from the apparatus and dried in a vacuum oven at 70-75° C.

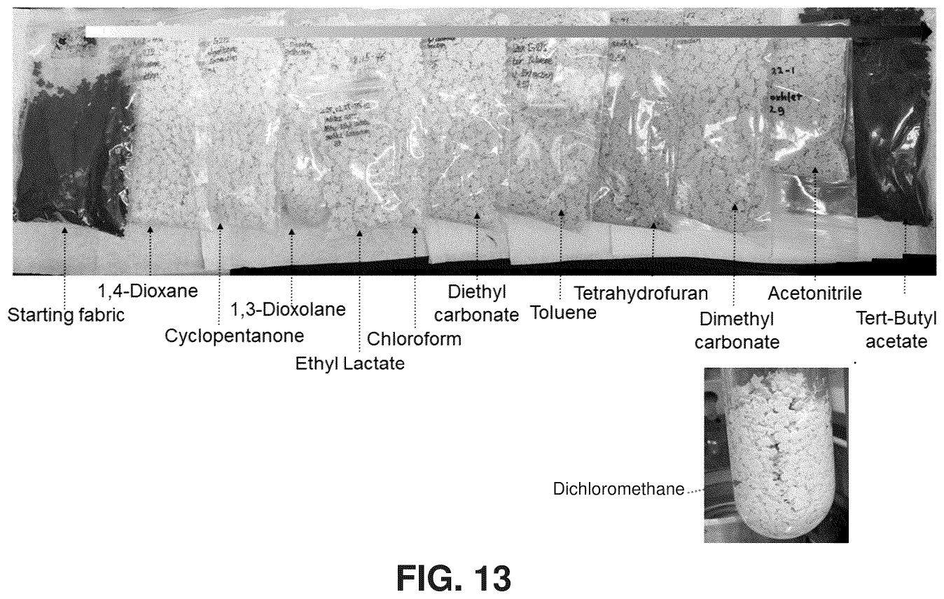

Results: FIG. 13 presents example polyester fabric samples following colorant removal using the different solvents in accordance with Experiment 3. These results demonstrate that that the safer solvents described herein (e.g. 1,4 dioxane, cyclopentanone, 1,3 dioxolane, ethyl lactate, diethyl carbonate and tetrahydrofuran), are at least or demonstrably better at removing the dyes using less safe solvents (e.g., toluene, acetonitrile, dichloromethane, chloroform).

### Experiment 4

Materials: Polyester (PET) fabric was used as the colored polyester material for dye removal study. Twelve different fabric samples (each about 60 g in mass) were tested, wherein each of the different fabric samples were richly colored with a different color of a disperse dye from a range of chemistries including azo, anthraquinone, coumarin and oxindazole (e.g., shown in FIG. 3 and others). The fabric samples included the following: Sample 1, dyed with disperse navy 79; Sample 2, dyed with disperse navy 291; Sample 3, dyed with disperse red 60; Sample 4, dyed with disperse red 167; Sample 5, dyed with disperse yellow 82; Sample 6, dyed with disperse blue 345; Sample 7, dyed with disperse blue 60; Sample 8, dyed with Terasil navy WW-GSN, Sample 8, dyed with Terasil black WW-KSN, Sample 10, dyed with Disperse Yellow 184; Sample 11, dyed with Dianix black XF, Sample 12, dyed with Dianix yellow brown XF. Cyclopentanone (CPO), ≥99%, Sigma-Aldrich), was used as the solvent.

Extraction Process: The dye extraction was performed separately for each of the different fabric samples. Each extraction process setup for each of the samples was the same as with Experiment 3, however CPO was used as the solvent used for the extraction processes.

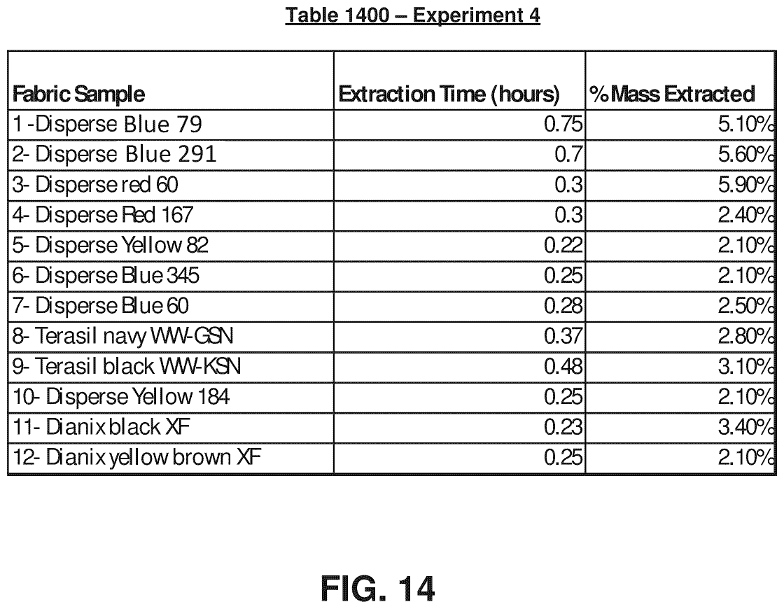

The respective extraction processes were carried out in a continuous flow manner while maintaining solvent reflux. The boiling point temperature of the solvent, cyclopentanone (CPO), was 130.6° C. The inner temperature remained between about 95° C. and about 110° C. over the duration of the extraction processes. The extraction processes were carried out for total durations of time (beginning from beginning of solvent reflux) needed for the observable color of the respective fabric samples to change from their initial color to white or substantially white. Once the extraction processes were complete, the purified (white) fabric was removed from the extraction chamber and dried. The aggregated colorant in the round bottom flask was further isolated (e.g., via evaporation of the solvent solution therefrom) and evaluated for composition and mass extracted. The results of Experiment 4 are presented in FIGS. 14-16.

Results: FIG. 14 presents Table 1400 illustrating the total extraction durations performed for the respective fabric samples in order for them to change from their initial color to white or substantially white, which ranged from about 0.2 hours to about 0.75 hours. Table 1400 also indicates the extracted mass percentage of the respective colorants.

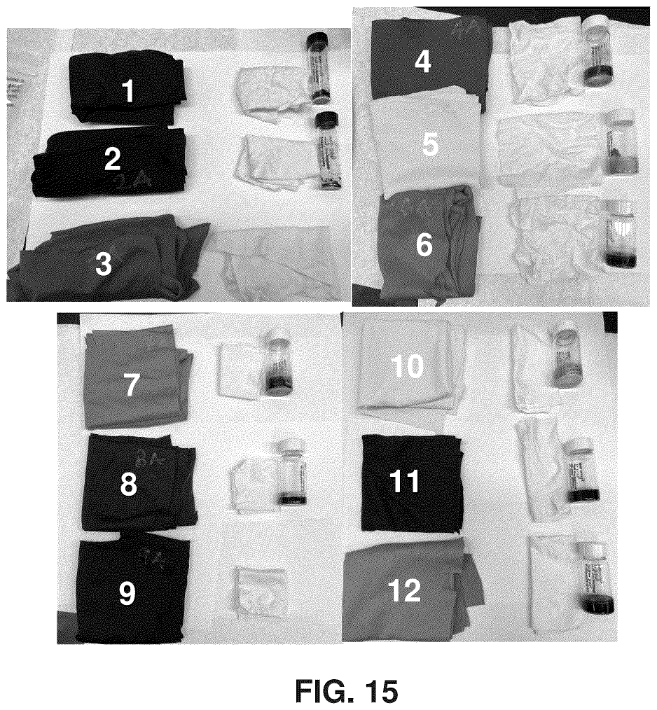

FIG. 15 presents images of the twelve different fabric samples (respectively labeled numbers 1-12 as corresponding to the samples 1-12 identified in Table 1400) before and after extraction. The glass vials imaged next to the purified fabric samples contain the removed dye as separated from the solvent/extract mixtures remaining in the boiling vessel following completion of extraction. FIG. 15 clearly demonstrates the effectiveness of CPO and Experiment 4 in removing all or substantially all disperse dye from the respective PET fabric samples.

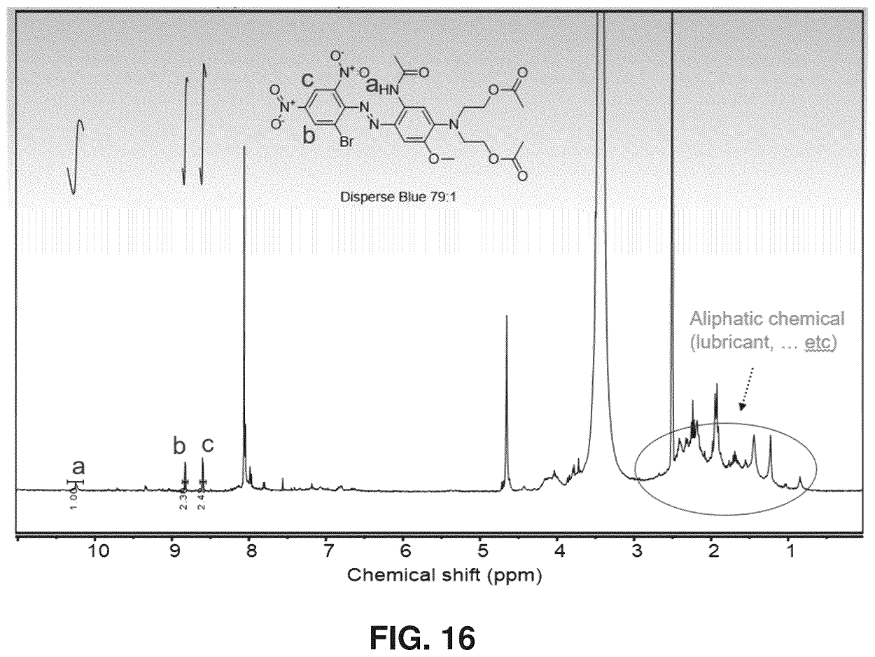

FIG. 16 present nuclear magnetic resonance (H-NMR) analysis results of the composition of the material extracted from Sample 1 (dyed with disperse blue 79). As shown in FIG. 16, in addition to the dye, a large amount of lubricants and other additives were also removed. Similar H-NMRs were observed for the other samples 2-12.

### Experiment 5

Materials: White PET fabric samples (without any dye) containing perfluoroalkylsubstances (PFAS), referred to herein as Sample 13 and Sample 14. Sample 13 was 46.49g and included a C8 fluorotelomer PFAS. C8 PFAS refers to a class of per- and polyfluoroalkyl substances (PFAS) that have eight carbon atoms in their fluorinated carbon chain—typically compounds like perfluorooctanoic acid (PFOA) or perfluorooctane sulfonate (PFOS). Sample 14 was 48.72g and included a 6C fluorotelomer PFAS. C6 PFAS refers to a group of per-and polyfluoroalkyl substances that have a six-carbon fully or partially fluorinated chain, typically including compounds like perfluorohexanoic acid (PFHxA) or perfluorohexane sulfonic acid (PFHxS). In addition, Sample 13 and Sample 14 included optical brighteners. Both of these types of chemicals can degrade the quality of recycled PET via existing chemical recycling processes, such as the VolCat process described in FIG. 12.

Extraction Process: The removal of both the PFAS and optical brightener substances was performed together for each of Samples 13 and 14. Each of the samples were processed separately. Each extraction process setup for each of the samples was the same as with Experiment 3, however CPO was used as the solvent used for the extraction processes.

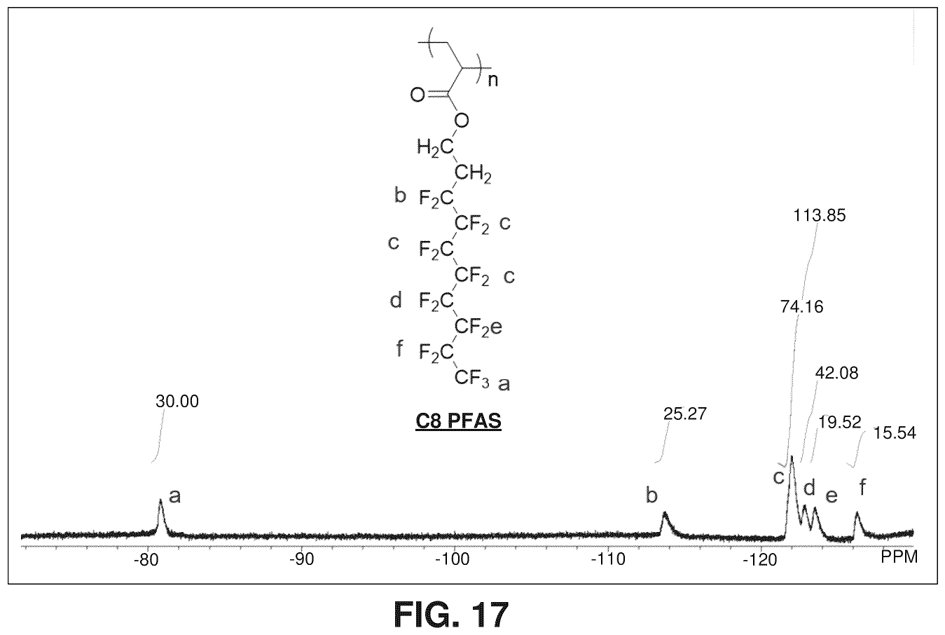

The respective extraction processes were carried out in a continuous flow manner while maintaining solvent reflux. The boiling point temperature of the solvent, cyclopentanone (CPO), was 130.6° C. The inner temperature remained between about 100° C. and about 115° C. over the duration of the extraction processes. The extraction processes were carried out for about 24 hours. Once the extraction processes were complete, the purified fabric was removed from the extraction chamber and dried. The aggregated extracted substances in the round bottom flask were further isolated (e.g., via evaporation of the solvent solution therefrom) and evaluated for composition and mass extracted. The results of Experiment 5 are presented in FIGS. 17-19.

Results: The total mass percentage of the extracted additives (PFAS and optical brightener) from Samples 13 and 14 was about 2.6%.

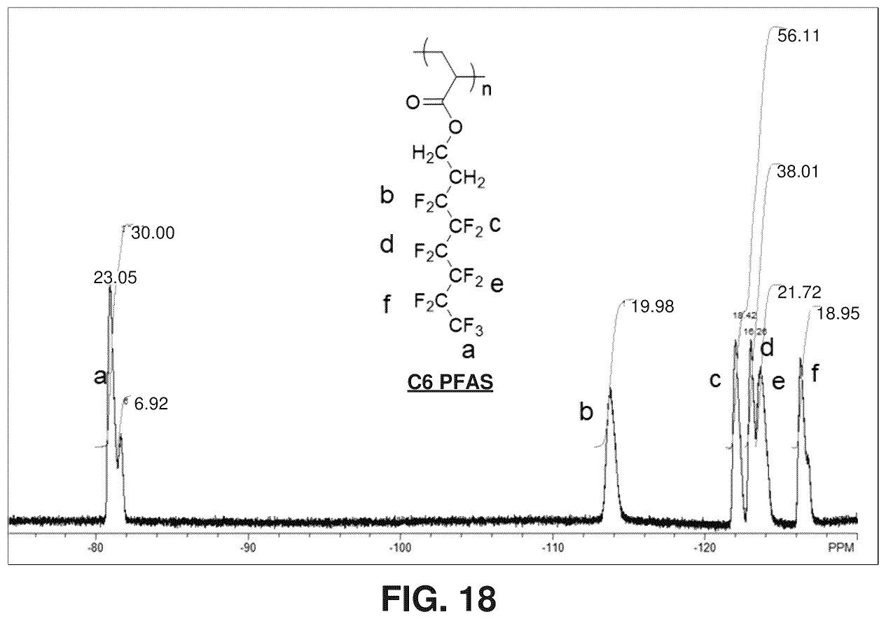

FIG. 17 presents the F-NMR results of the C8 fluorotelomer PFAS material extracted from Sample 13. FIG. 18 presents the F-NMR results of the C6 fluorotelomer PFAS material extracted from Sample 14. As shown in FIGS. 17 and 18, the PFAS was effectively extracted from Sample 13 and Sample 14 in accordance with Experiment 5.

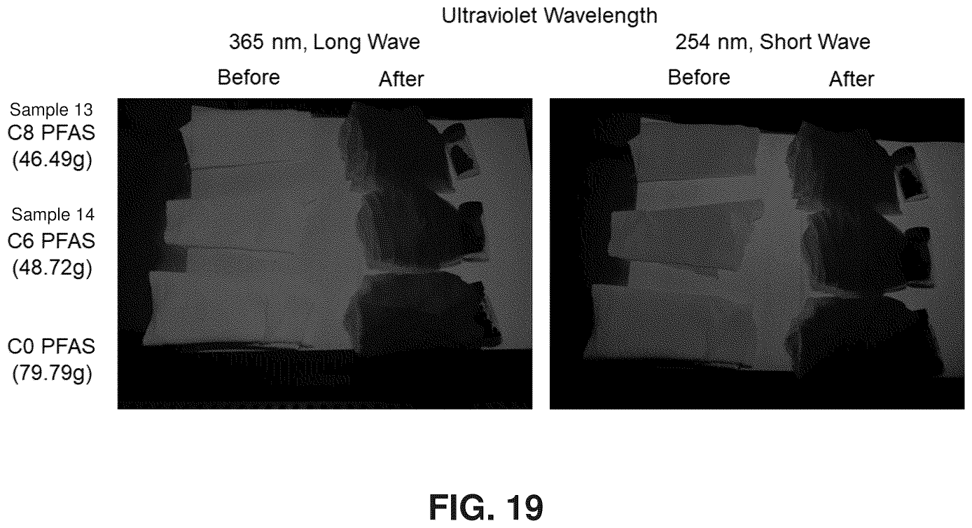

FIG. 19 presents an image demonstrating optical brightener removal in accordance with Experiment 5. Samples 13 and 14 (and an additional sample with C0 PFAS) before and after extraction in accordance with Experiment 5 were also exposed under ultraviolet (UV) light (both a 365 nanometer (nm) long wave and a 254 nm short wave) in a dark environment to evaluate differences in brightness attributed to the removal of optical brightener. The UV light test revealed the samples before extraction appearing a glowing bright white under the UV light, while the samples after extraction appeared dark without any white/glowing appearance, thus demonstrating effective removal of optical brightener using the disclosed methods.

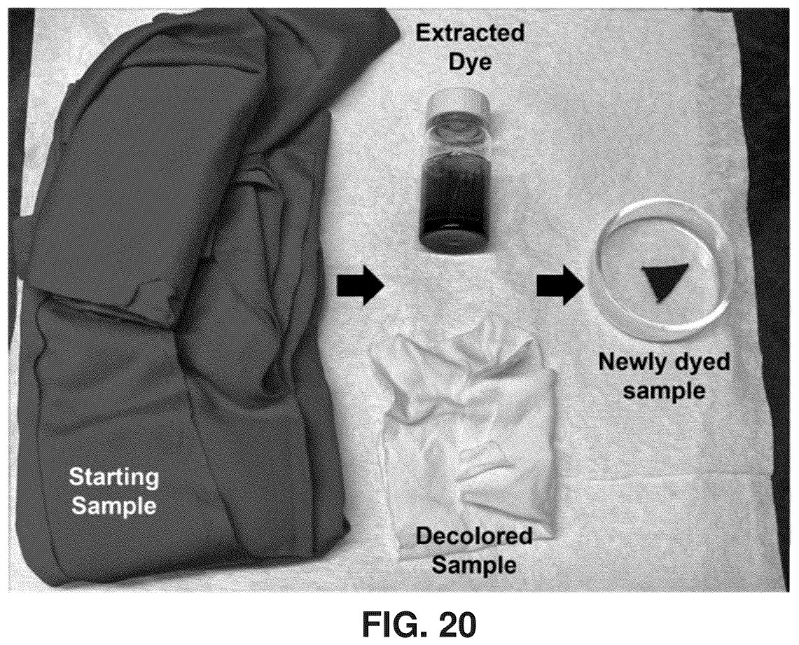

FIG. 20 demonstrates the efficacy of dying white PET fabric with disperse dye extracted in accordance with Experiment 3. In this example experiment, the red disperse dye (e.g., disperse red 60) extracted from Sample 3 in accordance with Experiment 3 was used to successfully dye a white polyester fabric sample in an immersion at 100° C. for 30 minutes, after which it was air dried.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

The Experimental examples described herein (e.g., Experiments 1-4) are set forth to provide those of ordinary skill in the art with a complete disclosure of how to make and use the aspects and embodiments of the invention as set forth herein. While efforts have been made to ensure accuracy with respect to variables such as amounts, temperature, etc., experimental error and deviations should be considered. Unless indicated otherwise, parts are parts by weight, temperature is degrees centigrade, and pressure is at or near atmospheric, or can be elevated relative to the boiling point and vapor pressure of a given solvent and the desired extraction temperature. All components were obtained commercially unless otherwise indicated.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for producing a purified polyester material, comprising:
contacting a heated solution comprising a solvent to a polyester material as positioned within a vessel, wherein the polyester material comprises one or more additive components, and wherein the solvent is selected from the group consisting of: a ketone, an ether, an ester, an alcohol, and/or a carbonate; and
removing at least some of the one or more additive components from the polyester material as a result of the contacting, resulting in a transformation of the polyester material into the purified polyester material.

2. The method of claim 1, wherein the at least some of the one or more additive components comprise a colorant.

3. The method of claim 1, wherein the at least some of the one or more additive components are selected from the group consisting of: a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime.

4. The method of claim 1, wherein the solvent is selected from the group consisting of:
cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate.

5. The method of claim 1, wherein the polyester material is selected from the group consisting of: polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly(butylene succinate) (PBS), poly(butylene adipate) (PBA) and other poly dialkyl diesters, polyalkalene alkanoates, polyalkylene succinates and adipates, polyhydroxyalkanoates, poly(lactic acid), and combinations thereof.

6. The method of claim 1, wherein the heated solution is heated to a temperature between about 50 degrees Celsius to about 140 degrees Celsius.

7. The method of claim 1, wherein the polyester material is formed as a fabric material, a textile material, a cloth material, a fibrous material, a granulate, a pellet, or a bottle flake material.

8. A method for producing a purified polyester material, comprising:
placing a polyester material in a chamber of a continuous flow extraction system for a duration of time, wherein the polyester material comprises one or more additive components;
performing an extraction process over the duration of time using a continuous flow reaction system, wherein the reaction process comprises:
contacting a condensed solvent solution comprising a solvent to the polyester material as positioned within the chamber, wherein the solvent is selected from the group consisting of: a ketone, an ether, an ester, an alcohol and/or a carbonate;
removing at least some of the one or more additive components from the polyester material as a result of the performing, resulting in a transformation of the polyester material into the purified polyester material; and
removing the purified polyester material from the chamber and removing residual solvent.

9. The method of claim 8, wherein the at least some of the one or more additive components are selected from the group consisting of: a colorant, a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime.

10. The method of claim 8, wherein the solvent is selected from the group consisting of:
cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate.

11. The method of claim 8, wherein the polyester material is selected from the group consisting of: polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly(butylene succinate) (PBS), poly(butylene adipate) (PBA) and other poly dialkyl diesters, polyalkalene alkanoates, polyalkylene succinates and adipates, polyhydroxyalkanoates, poly(lactic acid), and combinations thereof.

12. The method of claim 8, wherein the polyester material is formed as a fabric material, a textile material, a cloth material, a fibrous material, a granulate, a pellet or a bottle flake material, and wherein the purified polyester material comprises less than 1.0 percent by weight of the one or more additive components.

13. The method of claim 8, wherein the continuous flow reaction system comprises a condenser and a boiling vessel respectively coupled to the chamber, and wherein the reaction process comprises repeatedly or continuously:
forming a mixture comprising the condensed solvent solution and an extracted amount of the one or more additive components within the chamber as a result of the contacting;
collecting the mixture within the boiling vessel;
heating the boiling vessel to transform the solvent within the mixture into a vaporized solvent, wherein the vaporized solvent travels into the condenser and forms the condensed solvent solution; and
directing the condensed solvent solution into the chamber.

14. The method of claim 13, wherein the extraction process further comprises repeatedly or continuously:
reheating the condensed solvent solution up to a temperature greater than or equal to a boiling point of the solvent prior to directing the condensed solvent solution into the chamber; or
reheating the condensed solvent solution within the chamber up to the temperature greater than or equal to the boiling point of the solvent in association with the contacting.

15. A method for removing a colorant from a polyester material comprising the colorant, comprising:
placing a polyester material in a chamber of a continuous flow reaction system for a duration of time;
performing an extraction process over the duration of time using the continuous flow reaction system, wherein the reaction process comprises:
contacting a condensed solvent solution comprising a solvent to the polyester material as positioned within the chamber, wherein the solvent is selected from the group consisting of: a ketone, an ether, an ester, an alcohol and/or a carbonate;
removing at least some of the colorant from the polyester material as a result of the performing, resulting in a transformation of the polyester material into a purified polyester material; and
removing the purified polyester material from the chamber and removing residual solvent.

16. The method of claim 15, wherein the solvent is selected from the group consisting of:
cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate.

17. The method of claim 15, wherein the polyester material is selected from the group consisting of: polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly(butylene succinate) (PBS), poly(butylene adipate) (PBA) and other poly dialkyl diesters, polyalkalene alkanoates, polyalkylene succinates and adipates, polyhydroxyalkanoates, poly(lactic acid), and combinations thereof.

18. The method of claim 15, wherein the continuous flow reaction system comprises a condenser and a boiling vessel respectively coupled to the chamber, and wherein the reaction process comprises repeatedly or continuously:
forming a mixture comprising the condensed solvent solution and an extracted amount of the colorant within the chamber as a result of the contacting;
collecting the mixture within the boiling vessel;
heating the boiling vessel to transform the solvent within the mixture into a vaporized solvent, wherein the vaporized solvent travels into the condenser and forms the condensed solvent solution; and
directing the condensed solvent solution into the chamber.

19. The method of claim 18, wherein the continuous flow reaction system comprises a condenser and a boiling vessel respectively coupled to the chamber, wherein the reaction process comprises repeatedly or continuously:
forming a mixture comprising the condensed solvent solution and an extracted amount of the colorant within the chamber as a result of the contacting; and
collecting the mixture within the boiling vessel, and wherein the method further comprises:
recovering the colorant from the mixture; and
reusing the colorant in a material dying process.

20. A method for producing a recycled polyester material, comprising:
contacting a heated solution comprising a solvent to a polyester material as positioned within a vessel or chamber, wherein the polyester material comprises one or more additive components, and wherein the solvent is selected from the group consisting of: a ketone, an ether, an ester, an alcohol and/or a carbonate;
removing at least some of the one or more additive components from the polyester material as a result of the contacting, resulting in a transformation of the polyester material into a purified polyester material; and
transforming the purified polyester material into the recycled polyester material via a recycling process.

21. The method of claim 20, wherein the at least some of the one or more additive components are selected from the group consisting of: a colorant, a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime.

22. The method of claim 20, wherein the solvent is selected from the group consisting of:
cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate.

23. The method of claim 20, wherein the polyester material is selected from the group consisting of: polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly(butylene succinate) (PBS), poly(butylene adipate) (PBA) and other poly dialkyl diesters, polyalkalene alkanoates polyalkylene succinates, adipates, polyhydroxyalkanoates, poly(lactic acid), and combinations thereof.

24. The method of claim 20, wherein the polyester material is formed as a fabric material, a textile material, a cloth material, a fibrous material, a granulate, a pellet, or a bottle flake material.

25. The method of claim 20, wherein the recycling process is selected from the group consisting of, s a mechanical recycling process, a chemical recycling process, and a solvolysis process using glycolysis.
